(19) United States
(12) Patent Application Publication
(10) Pub. No.: US 2025/0294048 A1
(43) Pub. Date: Sep. 18, 2025

(54) SYSTEMS AND METHODS OF FACILITATING SECURITY TECHNOLOGY RATIONALIZATION

(71) Applicant: Lian Jin, North Potomac, MD (US)

(72) Inventor: Lian Jin, North Potomac, MD (US)

(21) Appl. No.: 19/078,231

(22) Filed: Mar. 12, 2025

Related U.S. Application Data
(60) Provisional application No. 63/564,364, filed on Mar. 12, 2024.

(51) Int. Cl. H04L 9/40

(52) U.S. Cl. CPC H04L 63/1433; H04L 63/20

(57) ABSTRACT

The present disclosure provides a method of facilitating security technology rationalization. Further, the method may include receiving, using a communication device, a security data from a user device. Further, the security data may include a list of security tools, security risks, and capability maturity assessment results. Further, the method may include analyzing, using the processing device, the security data in relation to a security reference data. Further, the analyzing may be based on an AI. Further, the method may include generating, using the processing device, a security result data based on the analyzing. Further, the generating may be based on the AI. Further, the method may include transmitting, using the communication device, the security result data to the user device.

### REFERENCE TO RELATED APPLICATIONS

This application claims the benefit of U.S. Provisional Patent Application No. 63/564,364, titled “SYSTEM AND METHOD TO RATIONALIZE SECURITY TECHNOLOGIES FOR MUTI/HYBRID-CLOUD ENVIRONMENT”, which is incorporated by reference herein in its entirety.

### FIELD OF THE INVENTION

The present disclosure generally relates to a field of data processing. More specifically, the present disclosure relates to systems and methods of facilitating security technology rationalization.

### BACKGROUND OF THE INVENTION

Many companies have embraced multi/hybrid cloud to run their businesses and accelerate digital transformation. At the same time, their workforce is becoming more mobile, and people want to be productive from everywhere. More permutation of data access, high-risk workloads, and many IT regulatory mandates have increased the security and compliance challenges. The current practice has the following challenges:
1. Manual & Unstructured Processes—Traditional security technology rationalization relies on manual assessments that are often one-off and subjective, lacking a standardized framework for mapping security tools to enterprise security capabilities. This results in inconsistent evaluations and inefficient security investments.
2. Lack of a Holistic Security Portfolio View—Existing approaches fail to provide a cohesive, organization-wide security portfolio assessment, making it difficult to identify risks, redundancies, and optimization opportunities across security domains, capabilities, and technology investments.
3. Failure to Analyze Risk & Identify Key Risk Clusters—Traditional methods do not ingest and analyze risks from enterprise risk registers or external threat intelligence sources. They lack a structured approach to mapping risk distribution across the security technology portfolio, leading to reactive security strategies instead of proactive risk mitigation.
4. Absence of Security Technology Capability Maturity Assessment—Without a structured Security Technology Capability (STC) maturity model, organizations cannot consistently evaluate their security capabilities, align security investments with capability gaps and risk clusters, or develop a strategic roadmap for security technology portfolio optimization.
5. Lack of AI-Driven Security Optimization—Current security technology rationalization, risk management, and capability maturity practices are manual, fragmented, and lack process automation. They do not leverage Generative AI (Gen-AI) or machine learning to perform data analytics, risk clustering, and generate highly relevant security recommendations in real-time.

The following are the limitations of existing solution in the market:
SIEMs, CASBs, and security monitoring platforms focus on event detection but do not help organizations rationalize their security technology investments and improve STC maturity.
Governance, Risk, and Compliance (GRC) tools (e.g., Archer, OneTrust) assist in policy & risk management but lack AI-driven security technology optimization, nor suggest tailored mitigation controls and suitable tools to reduce enterprise security risk.
Security audits and benchmarking frameworks provide point-in-time assessments but do not offer real-time AI-driven recommendations for optimizing security posture.

Therefore, there is a need for improved systems and methods of facilitating security technology rationalization, AI analysis and recommendations for optimized risk reduction, and security technology capability improvement that may overcome one or more of the above-mentioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides an AI-driven system and method for rationalizing security technology, risk reduction, and optimization of security technology capability in multi-cloud and hybrid-cloud environments. Using a structured AI-powered framework, the system enables organizations to assess, optimize, and manage cybersecurity tools, capability maturity, security risks, and compliance posture.

The system performs a multi-tier security portfolio analysis, comprising:
1. Tool Assay—Evaluate security tools for functional coverage, redundancy, and cost efficiency.
2. STC Maturity Assessment—This process uses structured models and predefined benchmarks to determine an organization's security technology capability maturity level.
3. Risk Cluster Analysis—AI-driven discovery of risk distribution on STC matrix & determine high-risk clusters in the security technology portfolio.
4. Portfolio X-Ray—Aggregates security insights into an interactive visualization, analyzing risk distribution across STCs and incorporating cost- and level-of-effort (LOE)-optimized risk mitigation recommendations.

The system includes a processing device and a communication device configured to the following:
Receive security tools and risk data from external sources;
Analyze security capability maturity by comparing technical capabilities with a security reference framework;
Use ai-driven semantic search to map security tools, risks, and compliance controls to security technology capabilities (stcs);
Generate cost- and loe-optimized security recommendations to reduce risks, streamline security tools, and improve security technology capability maturity; and
Transmit security assessment results and recommendations to user devices for decision-making.

By leveraging automated security assessments, AI-driven risk mitigation, and continuous optimization, this invention provides real-time, data-driven insights that enhance security investments, close security gaps, and improve security capability maturity while ensuring cost-effective and efficient risk reduction.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein and grant permission to reproduce the material only in connection with the reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating security technology rationalization, in accordance with some embodiments.

FIG. 4 illustrates a flowchart of a method 400 of facilitating security technology rationalization including generating, using the processing device 904, a capability benchmark data, in accordance with some embodiments.

FIG. 5 illustrates a flowchart of a method 500 of facilitating security technology rationalization including generating, using the processing device 904, a capability benchmark result data, in accordance with some embodiments.

FIG. 6 illustrates a flowchart of a method 600 of facilitating security technology rationalization including generating, using the processing device 904, a tool-assessment data, in accordance with some embodiments.

FIG. 7 illustrates a flowchart of a method 700 of facilitating security technology rationalization including analyzing, using the processing device 904, the tool-assessment response data, in accordance with some embodiments.

FIG. 8 illustrates a flowchart of a method 800 of facilitating security technology rationalization including generating, using the processing device 904, a tier data, in accordance with some embodiments.

FIG. 9 illustrates a block diagram of a system 900 of facilitating security technology rationalization, in accordance with some embodiments.

FIG. 10 is an illustration of a portfolio X-ray, in accordance with some embodiments.

FIG. 11 is an illustration of security technology capability matrix, in accordance with some embodiments.

FIG. 12 is an illustration of security result data, in accordance with some embodiments.

FIG. 13 is an illustration of a cost-value tier, in accordance with some embodiments.

FIG. 14A is an illustration of system architecture for online process, in accordance with some embodiments.

FIG. 14B is a continuation of FIG. 14A.

FIG. 15 is an illustration of system architecture for offline process, in accordance with some embodiments.

FIG. 16 is an illustration of mitigation control ranking, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one” but do not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a virtual machine, server less compute (e.g., Lambda), Kubernetes (K8s) Cluster, nodes and containers, server less K8S services (e.g., Fargate), a quantum computer, and so on. Further, one or more client devices and/or the server computer may be configured for executing a software application such as, for example, but not limited to, an operating system (e.g., Windows, Mac OS, Unix, Linux, Android, etc.), and application code in order to provide a user interface (e.g., GUI, touch-screen based interface, voice based interface, gesture based interface, etc.) for use by the one or more users and/or a network interface for communicating with other devices over a communication network. Accordingly, the server computer & workload may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding, searching and generating content. Further, the server computer & workload may include a communication device configured for communicating with one or more external devices. The one or more external devices & services may include, for example, but are not limited to, a client device, a third-party database, public database, a private database, AI Agents, Cloud services, APIs and so on. Further, the communication device may be configured for communicating with the one or more external devices or services over one or more communication channels. Further, the one or more communication channels may include a wireless communication channel and/or a wired communication channel. Accordingly, the communication device may be configured for performing one or more of transmitting and receiving of information in electronic form. Further, the server computer, virtual machines, Kubernete nodes may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, semantic search, Indexing, keyword search and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of input data, output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure relates to a system and set of methods to assess an entity's cybersecurity capabilities & technologies against multiple IT security standards, rationalize the technologies to secure entire hybrid/multi-cloud computing environments using effective and efficient technologies, and make recommendations that enable the entity to achieve a balance cyber defense with built-in security and compliance. A cloud-based application implements Security Technologies Rationalization (STR) methods and processes to discover security gaps, risks, and opportunities at multiple levels, generate strategic views, provide remediation recommendations to improve security effectiveness, close gaps, reduce risks, save money and improve cost efficiency.

Unlike traditional security management tools that focus on event monitoring (e.g., SIEMs) or policy-based compliance tracking (e.g., Archer for NIST 800-53), this system provides an AI-enhanced, structured approach to rationalizing security tools, prioritizing risk mitigation, and recommending cost effective security controls and technologies to enhance an organization's defense capabilities while minimizing costs and effort.

As organizations increasingly adopt multi-cloud and hybrid-cloud environments, they struggle with security technology sprawl, redundancy, and misalignment with enterprise security objectives. While traditional security tool rationalization, risk management methods exist, they are manual, unstructured, and lack a standardized framework to categorize security tools and risks effectively. This leads to fragmented decision-making and missed opportunities to optimize security investments & risk reduction.

To address the challenges documented in the background, organizations require a structured, AI-enhanced approach to security technology rationalization, risk reduction, and Security Technology Capability (STC) maturity improvement. The invention introduces foundational security technology rationalization (STR) methods that:
Standardize security tool classification using the Security Technology Capability (STC) Model to map security tools to enterprise security capabilities.
Provide a holistic security portfolio analysis, helping organizations identify security risks, technology gaps, and optimization opportunities across all security domains.
Prioritize risk mitigation controls by risk reduction potential and cost/LOE.
Perform structured capability maturity assessments, identifying security capability gaps and aligning security investments with enterprise risk posture.
Optimize security tool usage by eliminating redundancy, assessing cost efficiency, and improving risk-adjusted security maturity.
Align security technology capabilities with industry frameworks such as SCF, NIST 800-53, and ISO 27001 to ensure compliance.

The present disclosure encompasses the following key security rationalization methods:
Security Technology Capability (STC) Model & STC Matrix—A structured security technology capability model that defines distinct STC categories (e.g., Endpoint Malware Protection, Secret Management), align them with NIST functions and security domains.
Multi-Level AI-Driven Security Portfolio Analysis—The invention introduces a structured, multi-level assessment framework:
   Tool Assay—AI-driven evaluation of security tools based on functional overlap, gaps, cost efficiency, and stakeholder input.
   STC Maturity Assessment—Assess an organization's security technology capability maturity using STC CMMI benchmark, determine capability gaps, and provide most suitable recommendations to close the gap.
   Risk Cluster Analysis—AI-driven discovery of risk distribution on STC matrix & determine high-risk clusters in the security technology portfolio.
   Portfolio X-Ray—Interactive visualization of security technology gaps, risk clusters, and redundancies and cost inefficiency.
Method to resolve Tool Deduplication—Eliminates redundant investments and assigns tools to Tier-1, Tier-2, or Tier-3 categories using a structured 8-factor assessment model.
STR Scoring method—Uses a structured scoring system to rank security technologies based on cost-adjusted value, effectiveness, and strategic alignment with enterprise risk posture.
Security Technology Benchmarking & Maturity Modeling—Creates a baseline Security Technology Capability (STC) Benchmark by mapping security controls from various IT security standards, extracting common technology functions, and associating them with the appropriate STC maturity level.
Risk-Based Countermeasure Allocation—Determines built-in countermeasures for top cloud security risks, allocates them to STCs, and uses them to enhance STC definition and its CMMI model.

The present disclosure provides AI-powered systems and applications that implement the security technology rationalization, risk reduction, and maturity improvement methods described above. These AI-driven solutions automate security technology optimization, risk analysis, and tool selection to improve efficiency and effectiveness.

According to some embodiments, the present disclosure provides an AI-driven system and method for security technology rationalization, risk reduction, and Security Technology Capability (STC) maturity improvement in multi-cloud and hybrid-cloud environments. The system enables organizations to assess, optimize, and manage their security technology portfolio through a multi-level analysis:
1. 1.Tool-Level Analysis—Evaluates security tools for functional coverage, redundancy, and cost efficiency.
2. Capability Maturity Assessment—Determines an organization's security capability maturity using structured STC models and predefined benchmarks.
3. Risk Cluster Analysis—AI-driven discovery of risk distribution on STC matrix & determine high-risk clusters in the security technology portfolio.
4. Portfolio X—Ray-Determines risk cluster on the STC matrix & aggregates security insights into an interactive visualization for strategic decision-making.

The system includes:
An AI-powered STC definition engine that dynamically generates and updates STC definitions and their STC maturity models based on emerging security technologies, evolving controls & frameworks.
A semantic vector search and AI adjudication module that:
   Maps security tools, risks, compliance controls, and framework components to their most relevant STCs; and
   Identifies candidate security tools to implement mitigation controls and close various STC gaps.
An AI-driven risk mitigation engine that analyzes security risks and generates prioritized mitigation controls and the most suitable tools to maximize risk reduction with minimal cost and effort.
An AI-enhanced security tool recommendation engine that selects optimal security tools to implement mitigation controls and enhance security capability maturity.

This invention provides an AI-driven approach to eliminate security tool redundancies, optimize security investments, and enhance risk mitigation. It offers decision-makers a real-time, data-driven view of risks, gaps, and opportunities across their security technology portfolio, enabling continuous security optimization.

The present disclosure introduces the following key AI-driven capabilities:
AI-Powered Security Technology Rationalization Engine—A cloud-based application that automates STR processes across three levels: Portfolio, Capability, and Technology.
The application can:
   Ingest & normalize security technology data from multiple sources.
   AI-driven evaluation of security tools to determine functional overlap, gaps, and cost inefficiency.
   Perform security technology capability assessments to determine capability gaps.
   Ingest and analyze risks from external sources, determine key risk clusters on the STC matrix
   Generate Portfolio X-ray to visualize security tool gaps, security risks, tool overlaps & inefficiencies, and cost-saving opportunities.
Semantic Vector Search & AI Adjudication Module—AI-powered semantic mapping engine that:
   Maps security tools, risks, compliance controls, and framework components to their most relevant STCs.
   Identifies candidate security tools to implement mitigation controls and close STC gaps.
AI-Driven Risk Mitigation & Prioritized Control Generation—AI dynamically analyzes enterprise security risk data to:
   Map the risk to the STC matrix and identify risk clusters,
   Generate prioritized mitigation controls that maximize risk reduction while minimizing cost and effort.
AI-Enhanced Security Tool Recommendation Engine—AI-driven tool selection system that:
   Recommends the most suitable security tools for mitigating risks and closing capability gaps for a specific company's technology stack.
   Optimizes tool selection based on cost, risk reduction effectiveness, and organizational constraints.
Automated Compliance Mapping & Continuous Security Optimization—AI-powered compliance management system that:
   Dynamically maps controls in various IT security standards & frameworks (e.g., SCF, NIST 800-53, ISO 27001) to STCs.
   Continuously adapts STC & its CMMI model to evolving technologies & trends, compliance standards, and public frameworks.
AI-generated Strategic Security Technologies Map (SSTM) that reflects the current and future security technology plans.

### Security Technologies Rationalization (STR) Processes

The Security Technology Rationalization (STR) process is divided into 3 phases. Security Tools Rationalization (STR) process leverages AI-driven analysis, automation, and real-time security insights to accelerate decision-making, reduce redundant manual assessments, and deliver tangible results much faster.

### Key Enhancements in this Optimized Process

AI-Powered Automation: Reduces human effort in technology assessments, mapping, risk mitigation, and capability maturity improvement.
Faster Results: Eliminates redundant steps, enabling rapid security optimization within weeks instead of years.
Continuous Adaptation: Real-time updates based on new tools, compliance & security changes, and technology trends.

### PHASE 1: AI-Driven Portfolio X-Ray & Rapid Diagnosis

The goal is to perform an accelerated portfolio-wide analysis of security technologies, risks, and capability maturity using AI-driven assessments.

Key activities & AI automation include the following:
1. Automated Security Tool Mapping & Analysis
   Ingests & normalizes security tool data from vendors, APIs, and existing repositories.
   Uses semantic search & AI adjudication to automatically map tools to Security Technology Capabilities (STCs) and NIST Functions.
   AI identifies material security tool gaps, overlap, and cost-inefficiency.
2. STC Maturity Assessment
   Rapidly Assess the capability maturity of a company's built-in defense against the Security Technology Capability (STC) maturity benchmark, which AI derived from industry standards.
   AI determines maturity gaps in security capabilities.
3. AI power Risk Analysis & Portfolio X-Ray
   AI analyses portfolio-wide security risks and maps them to STCs to identify risk clusters.
   Portfolio X-Ray aggregates tool-level, capability gaps, and risk clusters to show portfolio-wide risks, gaps, and opportunities in various heatmaps and diagrams.
4. Automated AI-Generated Strategic Security Technologies Map (SSTM)
   AI automatically generates an initial SSTM to guide security investments & rationalization.

Key deliverables include the following:
AI-generated portfolio X-ray (Heatmap of security gaps, overlaps, risks);
Capability Benchmark & Radar Chart (Maturity assessment vs. target state);
Technology Assay Results (Tool overlap, gaps, redundancy);
Automated SSTM (Strategic Security Technologies Map for future planning); and
Timeline: 4 Weeks (Accelerated by AI-driven automation).

### PHASE 2: AI-Optimized Security Technology Rationalization & Risk Mitigation

The goal is to eliminate redundancy, close security gaps, and optimize security investments with AI-driven decision-making.

Key activities & AI automation include the following:
1. Automated Tool Rationalization & Cost-Value Optimization
   AI automates overlap resolution by detecting redundant technologies within each STC.
   To resolve duplication, AI ranks tools into T1 (retain), T2 (consider migration), and T3 (retire) based on value-to-cost analysis and makes rationalization recommendations.
   Analyze other tool data to determine other tool-level issues, such as coverage, cost inefficiency, and uneven license cost.
2. AI-Generated Mitigation Controls & Risk Reduction Recommendations
   AI dynamically generates mitigation controls for all critical & high risks.
   AI prioritizes mitigation controls into P0-P3 categories based on risk reduction potential and cost or level of effort (LOE).
3. Security Technology Capability (STC) Maturity Enhancements
   AI identifies missing maturity objectives and capability gaps, and provides recommendations per STC.
   AI recommends the most suitable tools to implement maturity improvement.
4. Automated Roadmap Creation & Budget Optimization
   AI recommends an optimized 3-year roadmap for security investments.
   AI predicts potential cost savings from tool retirements and security improvements.

Key deliverables include the following:
Optimized AI-Driven Security Technology Roadmap;
AI-Powered Tool Rationalization Report (Overlap resolution & cost savings);
Prioritized Risk Mitigation Plan (P0-P3 ranking);
Updated SSTM with Next-Phase Investments; and
Timeline: 4-8 Weeks.

### PHASE 3: AI-Integrated Governance & Continuous Optimization

The goal is to resolve outstanding tool redundancies & select best-fit security technologies based on AI-assisted competitive analysis and weighted selection criteria.

Key activities & AI automation include the following:
1. AI-Driven Security Tool Market Research & Selection
   AI collects data on existing tools in real-time and identifies other candidate tools that align with target-state capabilities & compatible with the core technology stake at an entity.
   AI ranks tools based on weighted selection criteria specific for an entity. (e.g., functionality, cost, usability, vendor support).
2. Final Bake-Off: Evaluating Remaining Tier 1 & Tier 2 Tools
   AI automates competitive analysis for tools that remain after Phase 2 rationalization.
   AI compares tools side-by-side using weighted selection criteria & latest data from vendors and other reputable sources.
   AI-generated reports inform stakeholders on the best course of action to resolve remaining redundancies.
3. Final Recommendations & Implementation Strategy
   AI creates a final report on recommended tools & retirement path.
   AI generates an optimized migration & implementation recommendation.

Key deliverables include the following:
AI-Driven Competitive Analysis & Market Research Report;
Final Tool Rationalization Decision Report (Bake-off results, recommendations);
Optimized Security Technology Portfolio (Post-final rationalization);
Implementation Strategy & Migration Plan; and
Timeline: 4-6 Weeks.

### Security Technology Capabilities (STC) Model

To perform Security Technology Rationalization (STR) for an entity, the system used a Security Technology Capabilities (STC) Model to represent a set of technological capabilities that can provide comprehensive protection for hybrid\multi-cloud environments. There are 94 technical capabilities organized into nine security technology domains and one Financial Fraud Management domain, as described below:
   1. Identity and Access Management (IAM): Identity and act management, an access management, an authentication management, an authoritative identity store, credential management, authentication management, authorization management, access certification, a privileged credential and access management, an IAM governance, audit, reporting, and secret management.
   2. Compute Security: Host secure configuration & device management, malware protection, detection, response, host & VM firewall, content filtering & proxy, host IDS/IPS, data-in-use protection, app whitelisting, trustworthiness protection, system backup & recovery, a virtualization security, secure browsing, mobile anti-malware, MDM/MAM security, secure IOT, sensor embedded device, secure collaborative devices (camera) and secure remote system access.
   3. Governance Risk & Compliance (GRC): IT security risk, third party risk assessment, policy and standard management, metrics and reporting, compliance management and audit management.
   4. Network Security: Network firewall gateway, netseg, flow/service control, data-in-transit security, enterprise email protection, secure wireless, secure remote access (VPN), NIDS/NIPS, packet captures, network malware protection, network anomaly detection, proxy and SSL visibility, secure DNS, DHCP, IPAM (DDI), CASB, DDOS mitigation, network visualize and risk analysis and network access control (NAC).
   5. Application Security: Web app firewall, thread modeling, app component security, SAST, DAST, container security, code/script protection, IAST, API & SOA security and secure IM, voice, video.
   6. Data security: Data-at-rest encryption, encryption key management, data loss prevention (DLP), data tokenization, masking, redaction, data discover, classify, tag, digital rights management, secure backup and recovery, secure disposal of data, digital signature/e-signature, file/data integrity protection, eDiscovery, legal hold, journaling, database monitoring & protection and data disclosure management.
   7. Threat and Vulnerability Management (TVM): Vulnerability scan and management, compliance validation, penetration testing, threat intel and management, deception, honey pot and threat hunting & investigation.
   8. Security Operations: Security patch & asset management, run book automation, SOAR, SIEM, monitoring, trend analysis, attack surface management, incident response, forensic/root cause analysis, malware analysis decompiler, UBEA, inside threat, control effective testing and security training & user testing.
   9. Financial Fraud Management (FFM): Transaction anomaly D & R, behavioral fraud detection, endpoint fraud protection, brand protection and fraud boundary protection.
   10. Others: Call tree & notification, mandatory security controls, secure configuration and availability (system, app, data).
Each STC capability represents a set of functions & objectives delivered by one or more security technologies. The capability will implement one or more security processes and controls and can support one or more security services. For example, Access Management Capability consists of functions such as role management, access request and approval, and auto-provisioning. It implements many security controls & processes as defined in NIST 800-53 and provides the technical capabilities that an IAM team can leverage to deliver Access Management service in an organization.
Each STC capability is mapped to security controls in multiple industry standards, such as ISO 27001, NIST 800-53, PCI, and SOC 2. This mapping is done directly or via the Security Control Framework (SCF). In the latter case, a STC capability is mapped to one or more SCF controls based on semantic analysis of capability functions & control description.
Each STC capability has a reference benchmark, which can be used to assess an entity's technology capability. The STC benchmark is derived from the corresponding SCF controls, reference functions, and features, countermeasures to top cloud security risks, industry differentiation, and the STC Capability Maturity Model.

During the Security Technology Rationalization, each security technology will be assigned to a STC capability where the technology provides most of its functions. It is possible that the technology can provide functions to 2 or more capabilities with an upper limit of three. For example: Access Management Capability, representative tools are Sailpoint and Omada, and native cloud security services are AWS Identity Center, Azure AD, and GCP IAM for the three leading cloud providers. Azure AD and GCP IAM are security technologies that can provide functions for multiple STC capabilities such as access management, authentication management, and authorization management.

### Security Technology Capability (STC) Matrix

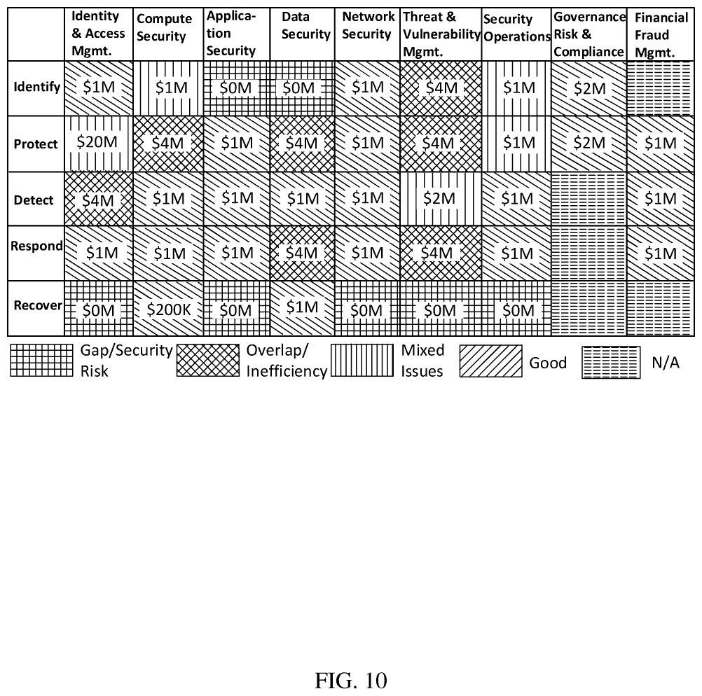

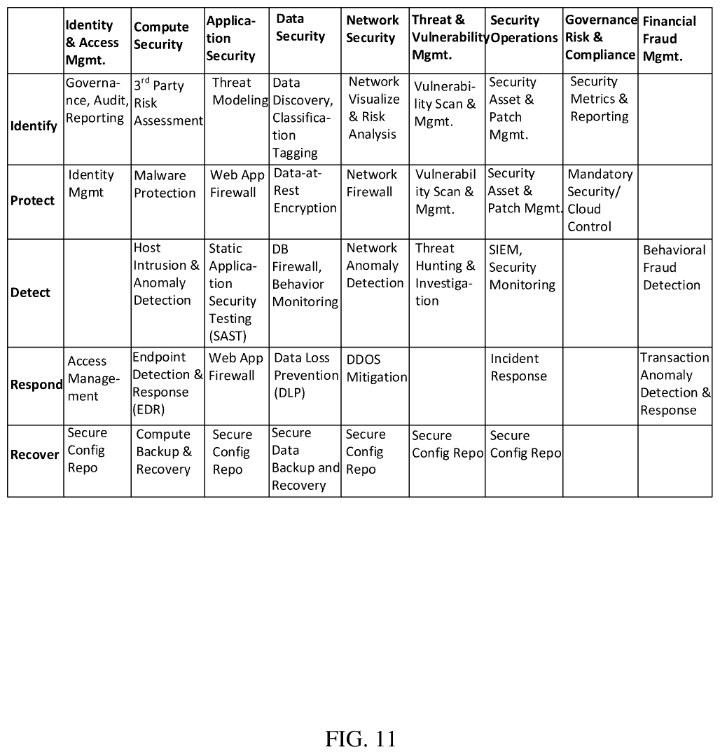

To profile an entity's overall cyber defense capabilities & identify strategic security concerns, the STC capabilities are further aligned with the NIST Cyber Security Framework (CSF) functions and security domains in a 2-D matrix. The security technology capability matrix is illustrated in FIG. 11.
Each block represents a set of security technology capabilities, aligned with a security domain and a NIST CSF function. The system will use this matrix and the capability benchmark and tool assay results and risk distribution to create a Portfolio X-ray for an organization and organize remediation recommendations. The Portfolio X-Ray will show the overall gaps, risks, opportunities of an organization's cybersecurity capabilities and capital spending. A sample is shown in FIG. 10.
With the Portfolio X-Ray, the system can quickly surface security issues at a strategic level and provide a launch point to drill down to gaps, risks, and opportunities at lower levels. Recommendation engines can provide specific remediation suggestions and the most relevant technologies to close the gap and reduce risks. The relevancy of technology recommendations is constantly being improved via continuous user feedback, community input, updated tool data, and improvement in the foundational model.

### Security Technology Capability (STC) Maturity Model

This invention introduces the Security Technology Capability (STC) Maturity Model to assess an entity's security technology capability maturity and set maturity targets in a standardized way. Unlike process maturity models such as CMMI, this model is designed specifically for security technology capabilities, which are implemented in software and hardware.

A key innovation is that an AI Assistant will be trained to:
Analyze CMMI definitions and related framework components/controls.
Use STC scope to generate maturity definitions for each STC capability dynamically.
Provide automated, real-time maturity assessments based on security control implementation and risk alignment.
This model includes five maturity levels, each with distinct criteria. It aligns with CMMI principles while incorporating security technology-specific measurements to maintain compatibility with industry practices.

The five maturity levels are:
1. L1—Ad-hoc practice
   Control is being performed but lacks completeness & consistency.
   Base practices of the process area are generally performed.
   The performance of these base practices may not be rigorously planned and tracked.
   Performance depends on individual knowledge and effort.
   There are identifiable work products for the process.
   Most cybersecurity activities and processes are manually driven.
2. L2—Compliance Driven—Compliance Driven Practices
   Applicable compliance controls are identified/selected & compliance expectation is known.
   Security requirements are derived from meeting compliance obligations.
   Key security processes, activities, and requirements are documented.
   Practice is tailored to meet these compliance requirements on an individual project or process area but is not institutionalized and consistently applied across the enterprise.
   Some security controls & processes are built into some projects to meet compliance requirements.
3. L3—Enterprise—Wide Standardization
   Everything at L2.
   Security requirements are derived from meeting BOTH compliance obligations & cybersecurity challenges.
   Security processes & controls are well-defined, documented, standardized, and consistently enforced across the enterprise.
   Comprehensive log/event collection and processing.
   Standard security tech is defined and used consistently on most projects and across lines of business.
   A good portion of technical controls & processes are built into most projects to meet cybersecurity & compliance requirements.
   Some metrics are defined, collected, and used.
   Processes & activities are periodically reviewed for conformance to policy & standards.
   Responsibility and authority for practices are assigned to personnel.
   Personnel performing the practice have adequate skills and knowledge.
4. L4—Quantitatively Controlled
   Everything at L3.
   Detailed metrics are defined, collected, and analyzed to enable governance oversight.
   Accountability for risk decisions by frontline businesses is formally assigned.
   The majority of risk-management processes & technical controls are automated across the enterprise.
5. L5—Continuously Improving Based on Quantitative Data in Real-time
   Everything at L4.
   Quantitative targets for security processes and system effectiveness and efficiency are established based on the organization's business goals.
   Continuous process & system improvement, based on quantitative feedback from performing the defined security processes & controls and piloting innovative ideas and technologies.
   Real-time, predictive analytics, Al & ML are used to improve the accuracy and effectiveness of automated security processes & systems.

### Method to Create Security Technology Capability (STC) Maturity Benchmark

To assess an entity's security technical capabilities & technologies and set maturity targets in a standard way, it is necessary to create a baseline Security Technology Capability (STC) benchmark aligned with multiple IT security standards. This is done by creating a meta-framework that can leverage the control mapping from a mapping component Security Control Framework (SCF) to map security controls from various IT security standards together. The meta-framework maps each SCF control to one or more STC capabilities. It then extracts technology functions from each SCF control & consolidates the maturity definition of each SCF control & use then to creates the corresponding STC capability maturity definition at an appropriate maturity level
The base capability maturity benchmark can be enhanced with different layers of enhancements, such as functions from the state-of-art technologies, countermeasures to the Top Cloud Security Risks, OWASP Top 10, and SANS 25.
All layers can then be consolidated and to produce an aggregated STC capability benchmark, which can then be vetted with human experts to produce a baseline STC benchmark.
The baseline benchmark can be further customized by selecting a different set of security control standards. In that case, the functions associated with delta controls will be removed or added to the baseline benchmark.

### Methods to Assess Security Technology Capability & Tools

The assessment is done at multiple levels: portfolio, capability, and technologies, with three methods: Portfolio X-Ray, Capability Benchmark, and Tool Assay.
Portfolio X-Ray. It is a populated Security Technology Capability (STC) matrix used to surface security gaps/risks at a strategic level. There are two paths to creating a Portfolio X-ray: 1) tool initiated or 2) capability initiated. On the 1st path, a list of security tools will be ingested, and the application will quickly provide a preliminary Portfolio X-ray. On the 2nd path, inputs from critical stakeholders are used to determine a set of STC capabilities valuable to an entity's cyber defense. This set will inform the scope of subsequent assessment & analysis. Capability level gaps and security risks will be integrated, analyzed, and aggregated to produce the initial Portfolio X-ray.
Regardless of the path of initiation, the capability and tool-level data will be combined with risk data in an updated Portfolio X-Ray to provide an enterprise view of an organization's cybersecurity posture. The Portfolio X-Ray shows aggregated gaps, risks and technology issues across multiple defense domains and NIST functions. A high watermark method is used to summarize capability gaps, security risks, and tool-level issues to ensure they are not being deluded during the aggregation.
For clarity, the Portfolio X-Ray can show this information in separate focused views: 1) risk view, Tools view, and Capability Maturity view.
Capability Benchmark. Each STC capability has a reference benchmark derived from the method described in the previous section. The capability benchmark assesses an entity's as-is cybersecurity capability and sets a target for the to-be capability maturity. In addition, the assessment can contain a set of questions to discover top capability gaps, key automatable processes and activities, top security risks, and quick-win opportunities.
Tool Assay. The Tool Assay module leverages AI to classify tools into best-fit STC and quickly identify material overlaps, gaps, and cost inefficiency. The subsequent steps use a set of questions to capture tool owners' disposition and other tool-level data, such as function and license utilization, asset coverage, initial purchase and operating costs. Collected data will be analyzed to determine the initial tool disposition, gaps, overlaps, cost inefficiency, asset coverage issues, and initial drop savings.

### Methods to Resolve Material Technology Duplications

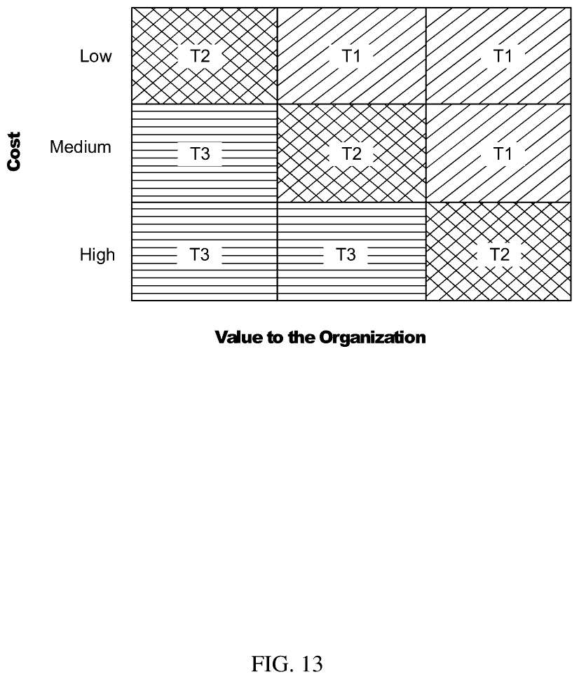

To resolve material technology duplication in a STC, a quantitative assessment method will be used to evaluate collective inputs from tool owners and SMEs. The analysis will separate security technologies into three tiers: tier-1, 2, and 3.
The evaluation is done on two dimensions: value dimension and cost dimension. On the value dimension, eight value factors will be considered: 1) Ability to provide the functions required at a selected maturity level, 2) Usability & Manageability, 3) Integra on & Compatibility, 4) Performance, 5) Scalability, 6) Cloud Support, 7) Vendor support, 8) Maturity & Completeness of Operational Processes.
Each factor scores from 1 to 10, with a maximum score of 80 per security technology. The numerical scores are collected from tool owners/SMEs in each entity. An average score for each factor will be added to obtain a total numerical score for a tool's value dimension. Numerical scores for all tools in a capability will be divided into three tiers (i.e., High, Medium, and Low) via a percentile analysis of the numerical score. Tool scores in the top 30% will have a high value; the bottom 30% will have a low value, and the rest a medium value.
On the cost dimension, three factors will be considered: 1) Subscription/License cost, 2) Level of Effort (LOE) to Implement, and 3) Support & Maintenance cost. LOE rating for a tool is an average rating obtained from tool owners/SMEs in multiple operating entities. For factors 1 and 3, each tool's per-unit cost is an average cost obtained from tool owners in different entities. The average per-unit costs for all the tools in a capability are ranked in 3 tiers: high, medium, and low via a percentile analysis. The final cost rating for a tool is a high watermark rating of the three cost factors.
Based on the value and cost rating, a tool will be placed in a cost-adjusted value tier, as shown below in FIG. 13.
Tier-1 tools offer the most value to an organization with the lowest cost, whereas tier-3 tools have the opposite characteristics. The recommendation will be to keep tier-1 tools, strategically retire tier-3 tools, and migrate tier-2 tools as opportunities arise.

### Methods Used to Dynamically Generate Prioritized & Actionable Mitigation Controls to Resolve a Security Risk

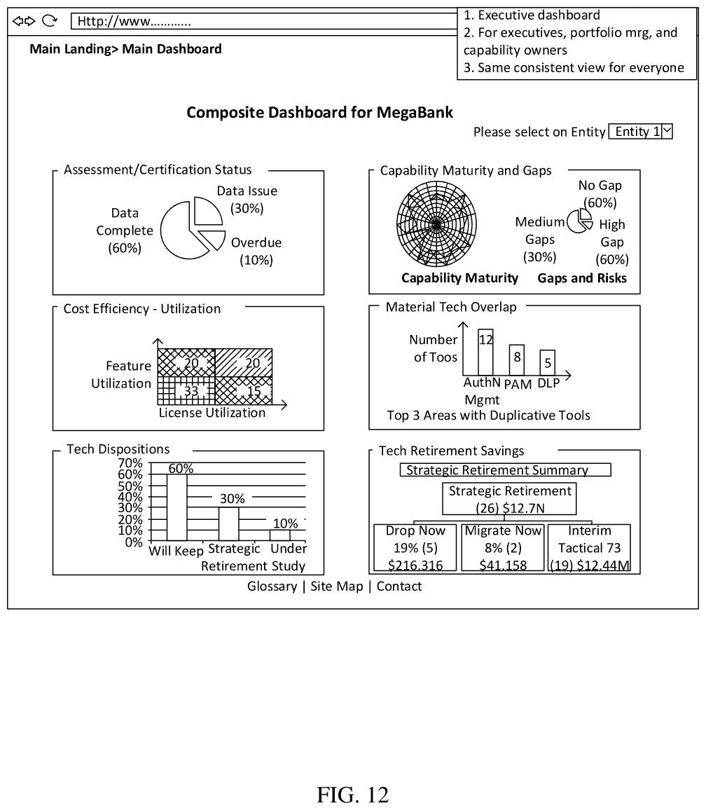

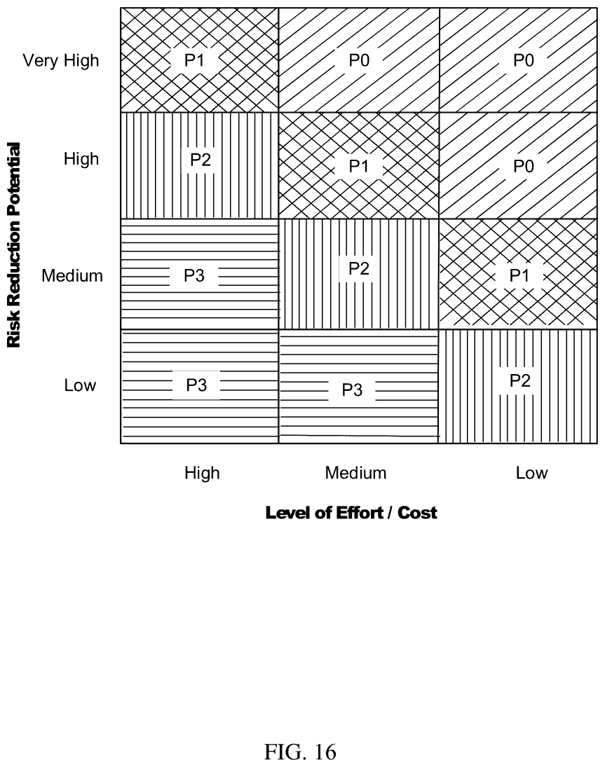

To generate prioritized & actionable mitigation controls. An AI Assistant will evaluate each mitigation control on 2 dimensions: 1) risk reduction potential, and 2) Level of effort/cost. It will rank each mitigation controls on a scale of P0, P1, P2, and P3, where P0 is a mitigation control with very high risk reduction potential and low LOE or cost. P3 is a control with exact opposite characteristics: very high LOE/cost, and low risk reduction potential. This mitigation control ranking is illustrated in FIG. 16.
Sample security posture of a company security capability portfolio is illustrated in FIG. 12.

### System Architecture & Processes

The system architecture has two parts: architecture for offline processes & architecture for online processes. The offline processes are AI-driven batch workflows that periodically ingests security tools, well-known risks, compliance controls, framework components, and technology trends, perform semantic mapping to Security Technology Capabilities (STCs) using vector search and AI adjudication, generate prioritized mitigation controls to well-known risks, update STC definitions and maturity models & various mappings, and stores the results in structured databases for real-time retrieval in online processes.

### System Architecture for Online Processes

The online architecture depicts a cloud-based, AI-driven system that enables real-time security tool rationalization, risk mitigation, STC capability assessment, and tool recommendations. The system integrates semantic search, AI-powered analysis, and structured workflows to:
Automate security tool rationalization.
Map tools, risks, and compliance controls to STCs.
Assess STC maturity & provide AI-driven recommendations.
Provide actionable security insights for security professionals.

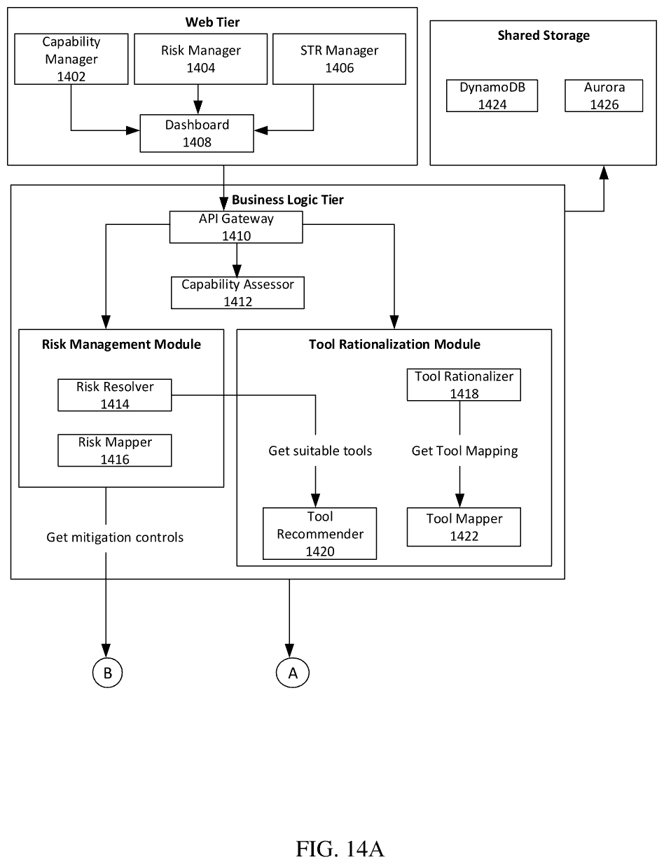

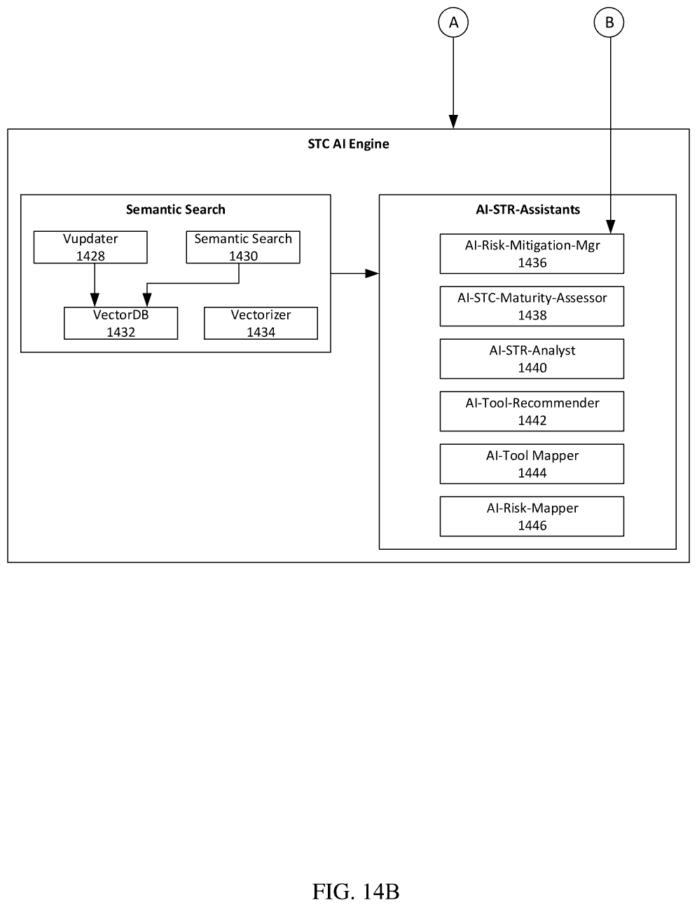

The system architecture is illustrated in FIGS. 14A and 14B, with components organized into four major subsystems:

```
1. Web Tier (User Interface & Presentation Layer)
  • Capability Manager (1402) − Enables users to:
        ○ View & assess STC capability maturity.
        ○ Display STC maturity Spider Diagrams.
        ○ Generate maturity improvement recommendations and
            suggest suitable tools.
  • Risk Manager (1404) − Enables users to:
        ○ Submit, analyze, and categorize security risks.
        ○ Display risk distribution across the STC matrix.
        ○ Provide prioritized risk mitigation controls with tool
            recommendations.
  • STR Manager (1406) − Allows users to:
        ○ Upload a list of security tools for rationalization.
        ○ Identify material tool gaps, redundancies, inefficiencies, and
            STC maturity gaps.
        ○ Generate remediation recommendations.
2. Business/Coordination Tier
  • API Gateway (1410):
        ○ Routes API requests from the Web Tier to backend APIs.
        ○ Enforces authentication and access control.
  • Tool Rationalizer (1418):
        ○ Calls Tool Mapper (1422) to obtain STC & NIST mappings.
        ○ Aggregates tools, metadata, and mapping information across
            STCs.
        ○ Calls AI-STR-Analyst (1440) to identify tool gaps and
            redundancies.
  • Tool Mapper (1422):
        ○ Checks AuroraDB (1426) for existing tool-to-STC/NIST
            mappings.
        ○ If no mapping exists, calls Semantic Search (1430)
            to suggest STCs & NIST functions.
        ○ Calls AI-Tool-Mapper (1444) to finalize STC/NIST mapping.
        ○ Stores final mappings in a relational database & cache.
  • Tool Recommender (1420):
        ○ Recommends tools for risk mitigation controls & security
            capability enhancement.
        ○ Suggests tools to close functional & maturity gaps.
  • Risk Analyzer (1417):
        ○ Checks relational DB for previously analyzed risks.
        ○ Calls AI-Risk-Analyzer (1447) to break a risk into well-
            organized sub-risks.
  • Risk Resolver (1414):
        ○ Determines prioritized, actionable mitigation controls.
        ○ Calls AI-Risk-Mitigation-Mgr (1436) to generate mitigation
            controls.
        ○ Calls AI-Tool-Recommender (1442) to suggest suitable tools
            to implement the mitigation controls.
  • Risk Mapper (1416):
        ○ Uses semantic search and AI-Risk-Mapper to classify risks
            under STCs.
3. STC AI Engine (AI Decision-Making & Analysis)
  • AI-STR-Analyst (1440):
        ○ Detects tool overlap, gaps, and inefficiencies.
        ○ Generates data for Portfolio X-Ray visualizations.
  • AI-STC-Maturity-Assessor (1438):
        ○ Evaluates STC capability maturity data and generates results
            for Spider Diagrams.
        ○ Identifies missing maturity components.
  • AI-Tool-Recommender (1442):
        ○ Suggest the most suitable tools for risk mitigation and STC
            maturity improvements.
  • AI-Risk-Analyzer (1447):
        ○ Breaks a complex risk into well-organized sub-risks ready
            for mitigation.
  • AI-Risk-Mitigation-Mgr (1436):
        ○ Generates prioritized & actionable risk mitigation controls.
  • AI-Tool-Mapper (1444):
        ○ Finalizes tool-to-STC/NIST mappings.
  • AI-Risk-Mapper (1446):
        ○ Finalizes Risk-to-STC/NIST mappings.
  • Semantic Searcher (1430):
        ○ Finds candidate STCs/NIST functions for tools.
        ○ Identifies candidate tools that close STC maturity gaps.
        ○ Identifies candidate tools that can implement mitigation
            controls.
  • Vectorizer (1434):
        ○ Use text embedding library to calculate the vector
            representation of a record
  • Vupdater (1428):
        ○ Store/update the vector representation and the corresponding
            record in the vector DB
4. Shared Storage (Database & Caching)
  • Relational DB (Aurora) (1426) − Stores:
        ○ Static mappings, metadata, STC definitions, risks,
            compliance standards, and public frameworks.
  • Cache (DynamoDB) (1424):
        ○ Caches frequently used mappings & analysis results for fast
            retrieval.
```

### Online System Processes

The online system enables real-time user interactions to support:

```
• Security tool rationalization
• Risk analysis & mitigation
• STC maturity assessments & recommendations
Below are the key online processes and how they are implemented:
1. Portfolio X-Ray of Security Tools
      • The purpose is to analyze an organization's security tools portfolio,
        identify redundant tools, and detect capability gaps.
      • The workflow includes the following:
          i. User uploads a list of security tools via STR Manager (Web
              Tier).
          ii. Tool Rationalizer (Coordination Logic) calls Tool Mapper to
              retrieve STC & NIST function mappings.
          iii. Tool Mapper checks AuroraDB for existing tool-to-STC/NIST
              mappings.
                ○ If a mapping exists, return the stored mapping.
                ○ If no mapping exists, proceed to:
                      a) Semantic search (VectorDB) retrieves candidate
                        STCs/NIST functions.
                      b) AI-Tool-Mapper determines the final STC/NIST
                        mapping.
          iv. Tool Rationalizer aggregates tool data across STCs and calls
              AI-STR-Analyst.
          v. AI-STR-Analyst identifies tool overlap, gaps, and
              inefficiencies and returns the results.
          vi. STR Manager displays the results via Portfolio X-Ray
              visualization.
2. Risk Categorization & STC Mapping
      • The purpose is to classify enterprise security risks into
        corresponding STCs for further risk mitigation planning.
      • The workflow includes the following:
          i. User submits a list of risks (CSV format) via the Risk
              Manager (Web Tier).
          ii.  Risk Mapper (Coordination Logic) checks AuroraDB for
              existing risk-to-STC mappings.
                ○ If a mapping exists, return the stored mapping.
                ○ If no mapping exists, proceed to:
                      a) Semantic search (VectorDB) identifies
                        candidate STCs.
                      b) AI-Risk-Mapper determines the final risk-to-
                        STC mapping.
          iii. Mapped risks are stored in AuroraDB for future retrieval &
              consistency.
          iv. The Risk Manager displays risk distribution & hotspots on the
              STC matrix.
3. AI-Driven Risk Mitigation & Tool Recommendations
      • The purpose is to generate prioritized risk mitigation controls and
        recommend the best tools to achieve optimal risk reduction at
        minimal cost & effort.
      • The workflow includes the following:
          i. Risk Manager pre-processes each risk, and if necessary, calls
              Risk Analyzer to break it into actionable sub-risks & better
              organize the sub-risks.
          ii.  For each risk or sub-risk, Risk Manager Calls Risk Resolver to:
                ○ Identify optimal mitigation controls.
                ○ Select the best tools to implement those controls.
          iii. Risk Resolver calls AI-Risk-Mitigation-Mgr to:
                ○ Generate prioritized & actionable risk mitigation
                    controls.
          iv. Risk Resolver performs Semantic Search (VectorDB) to:
                ○ Identify candidate security tools for implementing
                    mitigation controls.
          v. Risk Resolver calls AI-Tool-Recommender to:
                ○ Select best-fit security tools for implementing
                    mitigation controls with the optimal risk reduction,
                    cost, and LOE (Level of Effort).
          vi. The Risk Manager aggregates all recommendations, stores
              them in a Relational database, and displays them to the user.
4. STC Capability Maturity Assessment & Recommendations
      • The purpose is to evaluate the maturity level of STCs and generate
        recommendations for improving STC maturity.
      • The workflow includes the following:
          i. User selects one or more STC(s) for assessment via Capability
              Manager (Web Tier).
          ii.  Capability Manager retrieves the CMMI definition for the
              selected STC and collects:
                ○ Current state maturity level
                ○ Target maturity level
                ○ Additional user-provided notes
          iii. The Capability Manager calls the Capability Assessor
              (Coordination Logic) to begin the maturity analysis.
          iv. Capability Assessor calls AI-STC-Maturity-Assessor to:
                ○ Evaluate STC capability maturity.
                ○ Identify missing maturity objectives & functions.
                ○ Generate recommendations for improving maturity.
          v. Capability Assessor calls AI-Tool-Recommender to:
                ○ Suggest the most suitable security tools for
                    implementing maturity improvements.
          vi. Capability Manager generates a Spider Diagram displaying:
                ○ Current & Target State Maturity Levels.
                ○ Recommended actions for maturity improvement.
```

System Architecture for Offline Processes

```
1. Control to STC Mapping Subsystem
    • Control Gather (1624)
          ○ Collects security control sets & framework components from
              authoritative sources. The example control set is NIST 800-53,
              and the frameworks are TOGAF and Jericho.
    • S3 (Compliance Data) (1626)
          ○ Stores raw compliance standards & security frameworks and
              processing status.
    • Control Updater (1628)
          ○ Parses raw compliance data, identifies delta changes, extracts
              security controls & framework components.
          ○ Calls Vectorizer (1650) to create text embeddings for efficient
              AI-based search.
          ○ Updates the relational & vector databases.
    • Control Mapper (Step Function) (1630)
          ○ Orchestrates the control-to-STC mapping workflow using
              semantic search and AI adjudication.
          ○ Maps both compliance controls, framework components, and
              mitigation controls to their respective STCs.
2. Tool to STC Mapping Subsystem
    • Tool Scraper (1638)
          ○ Collects security tool data from vendor websites, APIs, and
              documentation.
    • Tool Extractor (1636)
          ○ Extracts key attributes from the collected tool data, including
              functionalities, features, supported security controls, and
              metadata.
    • S3 Tool Storage (1640)
          ○ Stores raw and processed tool data before further analysis and
              mapping.
          ○ Store them in a relational database & vector database.
    • Tool Mapper (Step Function) (1642)
          ○ Coordinates the tool-to-STC mapping workflow, calling
              semantic search & AI Assistants to determine the best STC
              category for each security tool.
3. Batch Risk Resolution Subsystem
    • Batch Risk Gather (1614)
          ○ Collects well-known risk datasets from OWASP Top 10,
              SANS Top 25, and CSA Top 12 Cloud Security Risks.
          ○ Translates risks into a structured format optimized for AI
              processing.
    • S3 Risk Storage (1616)
          ○ Stores raw risk data for preprocessing and AI analysis.
    • Batch Risk Manager (1618)
          ○ Coordinates the overall batch risk resolution workflow.
          ○ Extracts risks from stored documents and sends them to Risk
              Analyzer for decomposition into organized and actionable Risk
              components.
          ○ Calls Risk Resolver to determine prioritized & actionable
              mitigation controls for each Risk component.
          ○ Calls Risk Mapper to assign mitigation controls to relevant
              STCs.
          ○ Store Risk components, mitigation controls, and tool
              recommendations in relational database and cache.
    • Risk Analyzer (1620) (Same as Online System)
          ○ Checks whether a risk has been previously analyzed in
              AuroraDB. If not and it has not been processed before, calls
              AI-Risk-Analyzer to break down risks into organized Risk
              components and stores the results in a relational database for
              further processing.
    • Risk Resolver (1622) (Same as Online System)
          ○ Implements a workflow to generate prioritize actionable risk
              mitigation controls.
          ○ Uses AI-Risk-Mitigation-Mgr to generate mitigation control
              for a Risk component.
          ○ Uses AI-Tool-Recommender to suggest the most suitable
              security tools for implementing the mitigation controls.
4. STC Updater Subsystem
    • Delta Collector (1604)
          ○ Monitors technology trends, security tools, compliance
              standards, and security frameworks to detect material changes.
          ○ Obtain the changes & store them a file storage.
    • S3 Change Data (1610)
          ○ Stores change data collected from various security sources.
    • STC Manager (1602)
          ○ Coordinates STC definition and CMMI maturity model updates
              when material changes occur.
    • STC Updater (1608)
          ○ Ingests security controls, mitigation controls, & framework
              updates, determines whether a material change has occurred,
              and updates STC definitions accordingly.
    • STC Definition Manager (1612)
          ○ Updates STC descriptions, functionality, and scope when new
              security technology, trends, compliance & mitigation controls,
              and framework components emerge.
          ○ Called Semantic Search (1646) to determine affected STCs.
          ○ Gather relevant data & call AI-STC-Def-Assistant (1658) to
              determine which STC needs an update and recommend the
              updated definition.
    • STC CMMI Manager (1606)
          ○ Generates or updates STC maturity models (CMMI functions,
              objectives, and metrics) based on new security technology
              trends and framework changes.
          ○ Called Semantic Search (1646) to determine affected STCs.
          ○ Gather relevant data & call AI-STC-CMMI-Assistant (1656) to
              determine which STC needs an update and recommend the
              updated CMMI definition.
5. Shared Storage Subsystem
    • DynamoDB Cache Storage (1632)
          ○ Caches frequently used results produced by AI Assistants &
              updaters.
    • AuroraDB Relational Database (1634) − Stores structured data,
        including:
          ○ Tool data & metadata and mapping to STC and NIST functions
          ○ STC definitions & mappings
          ○ STC CMMI objectives and functions
          ○ Risk, risk components, mitigation controls & tool
              recommendations
          ○ Compliance controls and framework components
          ○ Mappings between tools, STC, compliance controls,
              framework components, risks, and mitigation controls.
6. STC AI Engine Subsystem
    • AI-Tool-Mapper (1652)
          ○ Determines the final STC classification for security tools based
              on tool metadata and candidate STCs.
    • AI-Control-Mapper (1654)
          ○ Determines final control-to-STC mapping using control
              definition and candidate STCs.
    • AI-STC-CMMI-Assistant (1656)
          ○ Creates CMMI maturity models for a STC based on mapped
              SCF controls & their maturity definitions.
          ○ Evaluates a set of candidate STCs & determines which STC is
              the most appropriate to incorporate new changes.
          ○ Recommend changes to the CMMI maturity models for the
              STC based on the latest information.
    • AI-STC-Def-Assistant (1658) − Generates or updates STC definitions
        based on changes in:
          ○ Technology trends,
          ○ Security tool functions,
          ○ Mapped compliance controls, mitigation controls,
          ○ Mapped framework components.
    • AI-Risk-Mitigation-Manager (1660)
          ○ Analyzes an enterprise security risk and generates prioritized,
              cost-optimized risk mitigation controls.
          ○ Ensure mitigation controls provide maximum risk reduction
              with minimum cost & implementation effort.
    • Vector Updater (1644)
          ○ Updates VectorDB entries when security tools, risks,
              compliance controls, mitigation controls, framework
              components, or STC changes occur.
    • Semantic Searcher (1646) − Uses semantic search to:
          ○ Map security tools, risks, compliance & mitigation controls to
              STCs,
          ○ Find candidate security tools for closing STC capability gaps.
          ○ Find candidate security tools to implement mitigation controls
              & reduce risk.
          ○ Find candidate STCs for changed tool functions, trends,
              compliance controls, and framework components.
    • VectorDB (1648) (Semantic Search Database) − Stores vector
        embeddings for:
          ○ Security tools
          ○ STCs definitions
          ○ STC CMMI functions & objectives
          ○ Compliance controls & mitigation controls
          ○ Framework components
    • Vectorizer (1650) − Generates vector embeddings for:
          ○ STCs, security tools, compliance controls, and framework
              components.
```

Offline System Processes

| 1. | Tool - STC Mapping Process: | |
|---|---|---|
| | • | Purpose: Automatically maps security tools to their most appropriate |
| | | Security Technology Capabilities (STCs) based on tool functionalities. |
| | • | Process Overview: |

| | |
|---|---|
| ∘ | Collect security tool data from vendors, APIs, and public |
| | sources. |
| | Extract tool metadata (e.g., features, functionalities, vendor |
| | details, tool names). |
| ∘ | Convert metadata into vector embedding for semantic search. |
| ∘ | Search Vector DB to find candidate STCs that closely match |
| | the tool's capabilities. |
| ∘ | AI-Tool-Mapper adjudicates the final STC mapping for each |
| | tool. |
| ∘ | Store final STC mapping in AuroraDB & cache in DynamoDB |
| | for real-time lookup. |

| | |
|---|---|
| • | Trigger: |

| | |
|---|---|
| ∘ | Scheduled batch job (weekly or monthly). |
| ∘ | Triggered by new tool ingestion. |

| 2. | Compliance Control / Framework Component - STC Mapping Process: | |
|---|---|---|
| | • | Purpose: Automatically maps compliance controls from regulatory |
| | | standards (NIST 800-53, ISO 27001, etc.) & Framework components |
| | | (SCF, TOFAG, Jericho, etc.) to their corresponding STCs to ensure |
| | | compliance alignment. |
| | • | Process Overview: |

| | |
|---|---|
| ∘ | Ingest the security standards and frameworks. |
| ∘ | Extract compliance controls or components and their metadata. |
| ∘ | Convert the controls or components into vector embeddings for |
| | semantic search. |
| ∘ | Search VectorDB for the most relevant STCs based on control |
| | functionality. |
| ∘ | AI-Control-Mapper determines the final compliance-to-STC |
| | mapping. |
| ∘ | Store final control-to-STC mapping in AuroraDB & cache in |
| | DynamoDB. |

| | |
|---|---|
| • | Trigger: |

| | |
|---|---|
| ∘ | Scheduled batch job (when new compliant standards or |
| | security framework are published). |
| ∘ | Triggered by changes in security frameworks (e.g., NIST |
| | updates). |

| 3. | STC Definition Update Process | |
|---|---|---|
| | • | Purpose: Automatically updates STC definitions when there are |
| | | material changes in technology trends, security standards & |
| | | frameworks, or tool capabilities. |
| | • | Process Overview: |

| | |
|---|---|
| ∘ | Delta Collector collects material changes (e.g., new security |
| | technology, new technological trends, updates in security |
| | controls & framework components). |
| ∘ | Extract and organize changed data into change unit. |
| ∘ | Use semantic search to find candidate STCs for each change |
| | unit. Determine affected STCs or no match. |
| ∘ | Use AI-STC-Def-Assistant to update or create STC definitions |
| | based on the existing STC definition and content of selected |
| | change units. |
| ∘ | Store up-to-updated STC definitions in AuroraDB & cache in |
| | DynamoDB. |

| | |
|---|---|
| • | Trigger: |

| | |
|---|---|
| ∘ | When a material change (mentioned above) has been detected. |
| ∘ | Periodic batch update (monthly or quarterly). |

| 4. | STC CMMI Model Update Process | |
|---|---|---|
| | • | Purpose: Generates and updates CMMI maturity model definitions for |
| | | each STC, including its functions, objectives, processes, and metrics |
| | | from CMMI definition of mapped framework components and new |
| | | security technology. |
| | • | Process Overview: |

| | |
|---|---|
| ∘ | Collect CMMI maturity definitions from mapped framework |
| | components & new security technology data. |
| ∘ | Calls AI-STC-CMMI-Assistant generates a new STC CMMI |
| | model definition and determines if there is material difference |
| | with existing model definition. |
| ∘ | Return the results: new updated definition or no change. |
| ∘ | Store updated CMMI maturity models in Aurora DB, |
| | DynamoDB, and Vector DB. |

| | |
|---|---|
| • | Trigger: |

| | |
|---|---|
| ∘ | Triggered by material changes in security frameworks. |
| ∘ | Scheduled batch job (quarterly or annually). |

| 5. | Vector Database Update Process | |
|---|---|---|
| | • | Purpose: Updates Vector DB with the latest embeddings for various |
| | | items, such as tools, STCs, and compliance controls, framework |
| | | components to improve AI-driven semantic search. |
| | • | Process Overview: |

| | |
|---|---|
| ∘ | Vectorizer computes embeddings for various items, such as |
| | security tools and compliance controls. |
| ∘ | Vector Updater refreshes the Vector DB storage with the latest |
| | embeddings and associated data. |

| | |
|---|---|
| • | Trigger: |

| | |
|---|---|
| ∘ | When new security tools, compliance controls, or STC |
| | definitions are added. |
| ∘ | Periodic batch job (weekly or monthly). |

| 6. | Data Storage & Optimization Process | |
|---|---|---|
| | • | Purpose: Ensures that structured data (e.g., STC definitions & |
| | | mappings, compliance controls & Mapping, Tools and mapping) is |
| | | properly stored and optimized for retrieval. |
| | • | Process Overview: |

| | |
|---|---|
| ∘ | Update mappings and data and archive older version. |
| ∘ | Optimize database indexes for faster retrieval. |
| ∘ | Back up and replicate critical security mappings in shared |
| | storage. |

The following are the aspects of the system disclosed herein:

| • | Aspect 1: AI-Driven Method for Security Technology Rationalization: An AI | |
|---|---|---|
| | driven method for rationalizing security technologies and assessing security | |
| | capability maturity in a multi-cloud or hybrid-cloud computing environment | |
| | using a multi-tier security portfollo analysis, the method comprises: | |
| | (a) | Performing a Tool Assay by: |

| | |
|---|---|
| ∘ | Evaluating security tools within each Security Technology |
| | Capability (STC) on functional coverage & utilization; and |
| ∘ | Determining tool level functional overlaps, gaps, cost |
| | inefficiency, and other improvement opportunity. |

| | |
|---|---|
| (b) | Performing an STC Maturity Assessment by: |

| | |
|---|---|
| ∘ | Assessing the capability maturity level of each STC based on |
| | predefined functions, objectives, and metrics; and |
| ∘ | Determining capability maturity gaps between the current and |
| | target security maturity levels. |

| | |
|---|---|
| (c) | Mapping Security Risks to STCs & Identifying Risk Clusters by: |

| | |
|---|---|
| ∘ | Ingesting security risk data from external data sources; |
| ∘ | Using semantic vector search to match risks to candidate STCs; |
| ∘ | Using AI assistant to adjudicate the risk mapping, and |
| ∘ | Identifying high-risk STC clusters that require prioritization for |
| | risk mitigation and technology investment. |

| | |
|---|---|
| (d) | Generating a Portfollo X-Ray of Security Assessment by: |

| | |
|---|---|
| ∘ | Aggregating results from the Tool Assay (step a) and STC |
| | Maturity Assessment (step b), and Risk Mapping (step c); and |
| ∘ | Producing an interactive visualization that provides a strategic |
| | security technology posture overview, including: |

| | |
|---|---|
| > | Tool redundancy & inefficiency, |
| > | Capability maturity gaps, |
| > | High-risk STC clusters, and |
| > | Prioritized mitigation opportunities |

| | |
|---|---|
| (e) | Defining a plurality of Security Technology Capabilities (STCs), |

wherein each STC represents a distinct security capability and is
associated with:

| | |
|---|---|
| ∘ | A set of technological functions & objectives that implement |
| | business processes & security controls; and |
| ∘ | A capability maturity model defining functions, objectives, and |
| | performance metrics for evaluating security maturity. |

| | |
|---|---|
| (f) | Mapping the STCs to a security domain and NIST Function, wherein a |

Security Technology Capability (STC) Matrix is generated that aligns
each STC with a corresponding:

| | |
|---|---|
| ∘ | Security domain (e.g., Data Security, Identity & Access |
| | Management); and |
| ∘ | NIST cybersecurity function (e.g., Identify, Protect, Detect, |
| | Respond, Recover). |

| | |
|---|---|
| (g) | Analyzing security tools within each STC by: |

| | |
|---|---|
| ∘ | Analyzing tool functional coverage & utilization; |
| ∘ | Identifying tool redundancy and cost inefficiencies; and |
| ∘ | Detecting tool gaps that impact security posture. |

| | |
|---|---|
| (h) | Assessing security capability maturity within each STC by: |

| | |
|---|---|
| ∘ | Applying predefined CMMI definitions to determine a current |
| | maturity state; and |
| ∘ | Determining gaps between the current and target maturity |
| | states, wherein the identified gaps serve as input for AI- |
| | generated recommendations. |

| | |
|---|---|
| (i) | Method to resolving security tools duplication within each STC: |

| | |
|---|---|
| ∘ | Assessing all tools in a STC by 8 different factors (e.g., |
| | functionality, manageability, cost, vendor support, etc.); |
| ∘ | Ranking them by value to the organization and Cost to |
| | implement; and |
| ∘ | Organizing tools into three tiers (T1-T3) to optimize |
| | rationalization decisions. |

| | |
|---|---|
| (j) | Ranking Mitigation Controls within each STC by: |

| | |
|---|---|
| ∘ | Evaluating each mitigation control based on risk reduction |
| | effectiveness and level of effort/cost to implement; and |
| ∘ | Prioritize mitigation controls on 4 levels, P0 - P3. |

| | |
|---|---|
| (k) | Generating a security technology rationalization output by: |

| | |
|---|---|
| ∘ | Aggregating security tool analysis, risk cluster analysis, and |
| | maturity assessments across STCs; and |
| ∘ | Producing a Portfollo X-Ray visualization that provides |
| | insights into: |

| | |
|---|---|
| > | Security posture at an aggregate level |
| > | Individual STC assessments |
| > | Specific security gaps, risk concentrations, and tool |
| | inefficiencies. |

| | |
|---|---|
| (l) | The capability maturity assessment of step (b) utilizes a predefined |

Security Technology Capability (STC) Maturity Model having
multiple maturity levels. The Portfollo X-Ray of step (d) is an
interactive visualization that enables a user to:

| | |
|---|---|
| ∘ | View the security posture at an aggregate level; |
| ∘ | Drill down into individual STC assessments; and |
| ∘ | Identify specific security gaps and tool inefficiencies. |

| | |
|---|---|
| (m) | Three-Level Analysis Engine: |

| | |
|---|---|
| ∘ | Integrates Tool Assay, Capability Benchmark, and Portfollo X- |
| | Ray to provide a structured, multi-tier security technology |
| | rationalization framework. |
| ∘ | Ensures tools are evaluated for functional overlap, redundancy, |
| | and cost inefficiency. |
| ∘ | Maps risk clusters to STCs, strengthening risk-driven |
| | rationalization decisions. |

| • | Aspect 2: Mapping security tools to STC) in a multi-cloud or hybrid-cloud | |
|---|---|---|
| | computing environment, ensuring accurate classification and real-time | |
| | updates, the system comprising: | |
| | (a) | An Offline Tool Mapping Process, wherein the system periodically: |

| | |
|---|---|
| ∘ | Ingests security tool metadata from multiple sources (e.g., |
| | vendor websites, APIs, product documentation). |
| ∘ | Uses semantic vector search to map tools to candidate STCs |
| | and compliance controls. |
| ∘ | Uses AI assistant to adjudicate the final tool mapping to STCs. |
| ∘ | Stores precomputed mappings in a database (AuroraDB, |
| | DynamoDB) for real-time analysis. |

| | |
|---|---|
| (b) | An Online Tool Mapping Process, wherein the system: |

| | |
|---|---|
| ∘ | Receives an uploaded security tool set from enterprise security |
| | systems. |
| ∘ | Normalizes tool names and cross-references the uploaded data |
| | with precomputed mappings for consistency. |
| ∘ | Assigns each tool to an STC based on precomputed mappings; |
| | if no mapping exists, AI-powered semantic search dynamically |
| | classifies the tool into candidate STCs. |
| ∘ | AI-Tool-Mapper adjudicates final STC placement, ensuring |
| | security tools are categorized in the most relevant security |
| | capability. |

| | |
|---|---|
| (c) | A Continuous Update Engine, wherein the system automatically: |

| | |
|---|---|
| ∘ | Integrates updates to security tool databases, ensuring new and |
| | deprecated tools are reflected in STC mappings. |
| ∘ | Monitors security technology changes, adjusting STC |
| | classifications accordingly. |
| ∘ | Ensures real-time accuracy of STC-tool mappings by |
| | dynamically adapting to evolving security capabilities. |

| | (d) | This system enhances the accuracy of security tool placement, |
|---|---|---|
| | | enabling organizations to visualize their tool landscape within |
| | | Portfollo X-Ray, quickly identify misclassified, redundant, or missing |
| | | tools, and streamline their security technology portfolio. |
| • | Aspect 3: An AI-driven system for dynamically generating, reviewing, and | |
| | updating Security Technology Capability (STC) definitions in a multi-cloud | |
| | or hybrid-cloud computing environment, the system comprising: | |
| | (a) | An STC Definition Engine configured to generate and update STC |
| | | definitions, including their purpose, functionality, scope, and |
| | | description, based on evolving security technologies and industry |
| | | standards. |
| | (b) | A Semantic Search Module configured to identify impacted STCs by |
| | | analyzing changes in security tool features, industry trends, public |
| | | security frameworks, regulatory controls, mitigation controls, and |
| | | forwarding candidate STC & detected changes to the AI-Powered |
| | | Adjudication Module. |
| | (c) | An AI-Powered Adjudication Module created to: |

| | |
|---|---|
| ∘ | Evaluate candidate STCs & relevant changes from the |
| | Semantic Search Module; |
| ∘ | Determine the appropriate STC to be updated or realigned; and |
| ∘ | Recommend the changes to the STC definition. |

| | |
|---|---|
| (d) | A Versioning and Governance Module, configured to: |

| | |
|---|---|
| ∘ | Track historical STC definition changes, security tool |
| | mappings, and compliance alignments. |
| ∘ | Maintain an audit log of all STC updates, ensuring traceability |
| | and compliance with regulatory requirements. |

| | |
|---|---|
| (e) | A Continuous Update Mechanism, wherein the system: |

| | |
|---|---|
| ∘ | Ingests security research, regulatory updates, and tool changes |
| | from trusted sources. |
| ∘ | Triggers AI-driven STC modifications whenever material |
| | updates are detected. |

| • | Aspect 4: A system for dynamically mapping compliance controls & | |
|---|---|---|
| | framework components from security regulations (e.g., NIST 800-53, ISO | |
| | 27001) and public frameworks (e.g., SCF) to Security Technology | |
| | Capabilities (STCs), the system comprising: | |
| | (a) | An Initial Regulatory Alignment Module to analyze regulatory |
| | | controls & security frameworks and map them to the most relevant |
| | | STCs based on definition and functional coverage. |
| | (b) | Continuous Compliance Mapping Engine to detect changes in |
| | | regulations, security frameworks, and Mitigation controls, ensuring |
| | | compliance & security mappings remain updated. |
| | (c) | An AI-Powered Adjudication Module created to: |

| | |
|---|---|
| ∘ | Evaluate relevant data from semantic search - candidate STCs |
| | & their metadata, data for compliance controls, mitigation |
| | controls, and framework component |
| ∘ | Adjudicate the final mapping between STC(s) and compliance |
| | controls, mitigation controls, and framework components. |

| | (d) | A Compliance Versioning and Retrieval System configured to |
|---|---|---|
| | | maintain historical compliance mappings, version tracking, and audit |
| | | logs for regulatory assessments. |
| • | Aspect 5: A system for dynamically defining, reviewing, and updating | |
| | Security Technology Capability (STC) functions, objectives, and metrics | |
| | across Capability Maturity Model Integration (CMMI) levels, the system | |
| | comprising: | |
| | (a) | CMMI finder identifies relevant SCF controls for an STC and gathers |
| | | associated control and CMMI maturity definition for SCF controls and |
| | | forwards this information to the AI Assistant for synthesizing an STC- |
| | | specific CMMI definition. |
| | (b) | An AI Assistant that processes the STC definition, evaluates mapped |
| | | security controls and their CMMI definitions, and recommends |
| | | optimized CMMI definition for each STC, including functions, |
| | | objectives, and performance metrics. |
| | (c) | A Versioning and Governance System that maintains historical |
| | | versions of STC CMMI definitions, ensuring continuous updates and |
| | | compliance with evolving security standards. |
| • | Aspect 6: A system for recommending security tools to close Security | |
| | Technology Capability (STC) gaps, the system comprising: | |
| | (a) | A Tool Candidate Module that uses semantic search to identify |

candidate security tools for resolving one or more of the following
STC gaps:

| | |
|---|---|
| ∘ | Absence of a security tool for an STC (e.g., no anti-virus or |
| | EDR tool in Endpoint Protection, Detection, and Response |
| | STC); |
| ∘ | Partial functional coverage within an STC (e.g., multiple |
| | authentication tools exist but none provide risk-adjusted |
| | authentication); and |
| ∘ | Maturity-level deficiencies within an STC (e.g., an anti-virus |
| | tool detects known viruses but lacks zero-day detection using |
| | ML). |

| | |
|---|---|
| (b) | An AI-Driven Tool Evaluation Module that: |

| | |
|---|---|
| ∘ | Assesses candidate tools based on functional coverage, |
| | effectiveness in closing the gap, cost, and organization-specific |
| | criteria; |
| ∘ | Determines the optimal tool or combination of tools to close |
| | the identified STC gap; and |
| ∘ | Ranks recommendations based on organization-defined |
| | selection priorities. |

| | |
|---|---|
| (c) | Continuous Update Engine that: |

| | |
|---|---|
| ∘ | Ingests new security tool data, including emerging threats and |
| | evolving compliance requirements; and |
| ∘ | Continuously refines AI-driven tool recommendations based on |
| | real-time security needs. |

| • | Aspect 7: A system for analyzing security risks, generating prioritized risk | |
|---|---|---|
| | mitigation controls, and recommending security tools to implement the | |
| | generated controls, the system comprising: | |
| | (a) | An AI-Powered Risk Mitigation Control Generation Module that: |

| | |
|---|---|
| ∘ | Analyzes security risk or risk component; and |
| ∘ | Generates prioritized risk mitigation controls based on risk |
| | reduction effectiveness, cost, and implementation effort. |

| (b) | A Security Tool Candidate Module that uses semantic search to |
|---|---|
| | identify candidate security tools capable of implementing the AI- |
| | generated risk mitigation controls. |
| (c) | An AI-Driven Tool Ranking Module that: Evaluates and ranks security |

tools based on:

| | |
|---|---|
| ∘ | Risk reduction effectiveness; |
| ∘ | Cost and implementation effort; |
| ∘ | Compatibility with must-have security tools; and |
| ∘ | Other organization-specific ranking criteria. |

| | (d) | Dynamically adjusts recommendations based on organization-specific |
|---|---|---|
| | | priorities and generates AI-driven explanations for rankings to enhance |
| | | transparency. |
| • | Aspect 8: A system for analyzing security risks and mapping them to Security | |
| | Technology Capabilities (STCs), the system comprising: | |
| | (a) | An AI-Powered Risk Mapping Module that: |

| | |
|---|---|
| ∘ | Dynamically analyzes security risks; and |
| ∘ | Categorizes risks under relevant STCs. |

| | |
|---|---|
| (b) | A Portfollo Risk Analysis Engine that: |

| | |
|---|---|
| ∘ | Aggregates and quantifies risk across multiple STCs; |
| ∘ | Identifies high-risk areas; and |
| ∘ | Determines overall risk exposure across the organization's |
| | security portfolio. |

| | |
|---|---|
| (c) | A Visualization and Insights Module that generates an interactive |

Portfollo X-Ray visualization, providing:

| | |
|---|---|
| ∘ | A real-time aggregated view of risk distribution across STCs; |
| | and |
| ∘ | Actionable insights to prioritize risk mitigation efforts. |

| • | Aspect 9: A method for AI-driven security technology rationalization in a | |
|---|---|---|
| | multi-cloud or hybrid-cloud computing environment, the method comprising: | |
| | (a) | Receiving, using a communication device, security data from a user |

device, wherein the security data comprises:

| | |
|---|---|
| ∘ | A list of security tools, |
| ∘ | A list of security risks, and |
| ∘ | Capability maturity assessment results; |

| (b) | Processing, using a computing system, the security data to analyze |
|---|---|
| | security technology portfollo elements, determine security risks, gaps, |
| | and deficiencies, and identify optimization opportunities; |
| (c) | Analyzing, using an ai-driven system, the processed data in relation to |

a security reference dataset to:

| | |
|---|---|
| ∘ | Evaluate security technology gaps, issues, and risk exposure |
| | across the security portfolio; |
| ∘ | Determine capability maturity deficiencies & recommendations |
| | to close the gaps; |
| ∘ | Determine risk cluster & prioritize risk mitigation strategies. |
| ∘ | Identify optimization opportunities for security tools, stc |
| | maturity, and cost efficiency; |

| | |
|---|---|
| (d) | Generating, using the computing system, ai-driven outputs comprising: |

| | |
|---|---|
| ∘ | Security technology rationalization (str) results & insights: ai- |
| | driven findings on tool-level issues, capability maturity, and |
| | risk clusters; |
| ∘ | Portfollo x-ray comprising a set of interactive visualizations |
| | summarizing security posture, tool redundancies, risk clusters, |
| | and capability maturity gaps; |
| ∘ | Ai-driven recommendations comprising optimized strategies |
| | for risk reduction, maturity improvement, tool rationalization, |
| | and cost efficiency. |

| • | Aspect 10: The method of aspect 9 further comprises: | |
|---|---|---|
| | (a) | Obtaining, using the processing device, security standard data based |
| | | on industry regulations, organizational policies, and mapped STC |
| | | frameworks, wherein the security standard data comprises an |
| | | information technology security standard corresponding to at least one |
| | | of the security tool and the security target; |
| | (b) | Identifying, using the processing device, a standard capability dataset |
| | | based on the security standard data, wherein the standard capability |
| | | dataset defines technical capabilities required to implement the |
| | | information technology security standard in the organization; |
| | (c) | Generating, using the processing device: |

| | |
|---|---|
| ∘ | A Security Technology Capability (STC) definition dataset, |
| | wherein the dataset comprises dynamically generated STC |
| | definitions aligned with evolving security technologies, |
| | industry frameworks, and compliance standards; and |
| ∘ | A capability benchmark dataset mapping security posture to |
| | predefined maturity levels based on compliance frameworks |
| | and industry best practices, wherein the security reference |
| | dataset comprises the capability benchmark dataset. |

| • | Aspect 11: AI-driven method for rapid and automated Security Technology | |
|---|---|---|
| | Rationalization, Risk Reduction, and STC Maturity Improvement, the method | |
| | comprising: | |
| | (a) | receiving, using a communication device, security data from a user |

device, wherein the security data comprises:

| | |
|---|---|
| ∘ | Security tools, |
| ∘ | Security risks, and |
| ∘ | STC capability maturity assessment data; |

| | |
|---|---|
| (b) | processing, using a computing system, the security data to: |

| | |
|---|---|
| ∘ | normalize and map security tools to corresponding STCs, |
| ∘ | resolving tool duplication by ranking tools into multiple tiers |
| | based on a multi-factor analysis, |
| ∘ | decompose risks into structured risk components, and map |
| | risks to STCs, |
| ∘ | analyze STC maturity gaps with the STC maturity frameworks |
| | and industry benchmarks, prioritizing mitigation based on |
| | compliance requirements and security deficiencies; |

| | |
|---|---|
| (c) | analyzing, using an AI-driven system, the processed data against a |

security reference dataset to:

| | |
|---|---|
| ∘ | identify security technology gaps, redundancies, and cost |
| | inefficiencies across the entire portfolio, |
| ∘ | analyze risks & identify risk clusters on the Security |
| | Technology Capability matrix, |
| ∘ | prioritize risk mitigation controls based on risk reduction |
| | effectiveness, cost, and level of effort (LOE), |
| ∘ | determine gaps in security technology capability & STC |
| | maturity; |

| | |
|---|---|
| (d) | generating, using the computing system, AI-driven outputs |
| | comprising: |

| | |
|---|---|
| ∘ | Security Technology Rationalization (STR) Results & Insights |
| | comprising: |

| | |
|---|---|
| > | Security Tool Analysis, identifying technology gaps, |
| | overlaps, asset coverage, and cost inefficiencies, |
| > | Risk Cluster Analysis, detecting high-risk areas and |
| | prioritizing mitigation strategies, |
| > | STC Maturity Assessment, identifying critical |
| | capability & maturity gaps; |

| | |
|---|---|
| ∘ | Portfollo X-Ray (Aggregated Security Visualization) |
| | comprising: |

| | |
|---|---|
| > | Heat maps, spider diagrams, and security posture |
| | visualizations summarizing gaps, risk clusters, overlaps, |
| | and inefficiencies, |
| > | Drill down capabilities into lower-level assessments to |
| | show tool-level issues, capability-level issues, or risk- |
| | level issues. |

| | |
|---|---|
| ∘ | AI-Driven Recommendations for Security Optimization, risk |
| | reduction, and maturity improvement comprising: |

| | |
|---|---|
| > | Strategic & tactical recommendations for tool |
| | streamlining, cost reduction, risk mitigation, and STC |
| | maturity improvement, |
| > | AI-prioritized mitigation controls based on risk |
| | reduction effectiveness, cost, and level of effort (LOE), |
| > | AI-driven tool recommendations for the most suitable |
| | tools to implement mitigation controls, close capability |
| | gaps, optimize security investment, and enhance STC |
| | maturity. |

| • | Aspect 12: AI-Driven Methods for Establishing, Evolving, and Utilizing | |
|---|---|---|
| | Security Technology Capabilities (STCs) for Security Technology | |
| | Rationalization (STR), Risk Reduction, and Maturity Improvement | |
| | comprising: | |
| | (a) | An AI-driven method for defining, maintaining, and utilizing Security |

Technology Capabilities (STCs) as a framework for security
technology rationalization (STR), risk reduction, and maturity
improvement, the method comprising:

| | |
|---|---|
| ∘ | Defining a plurality of STCs, each representing a distinct |
| | security technology capability mapped to: |

| | |
|---|---|
| > | Security domains (e.g., Data Security, Identity & |
| | Access Management). |
| > | Security functions in public frameworks (e.g., NIST |
| | Cybersecurity Functions). |
| > | Security technologies and emerging technological |
| | trends. |
| > | Compliance frameworks (e.g., NIST 800-53, ISO |
| | 27001, SCF). |
| > | Mitigation controls aligned with security risks. |

| | |
|---|---|
| ∘ | Continuous updating STC definitions to reflect technological |
| | evolution and regulatory & standard updates. |
| ∘ | Use semantic search and AI to recommend modification to an |
| | existing STC or create a new STC. |

| | |
|---|---|
| (b) | An AI-driven method for establishing & continuously Updating the |

STC Maturity Model & using it to assess & improve the maturity of an
organization's built-in defense capabilities, comprising:

| | |
|---|---|
| ∘ | Developing and continuously updating an STC Maturity |
| | Model, defining multiple levels of security capability maturity, |
| | based on: |

| | |
|---|---|
| > | Alignment with security & compliance frameworks, |
| | risk mitigation strategies, and technological trends. |
| > | Effectiveness of built-in security capabilities in |
| | preventing, detecting, and responding to cyber threats. |
| > | Functional completeness relative to STC definition & |
| | mapped security elements. |

| | |
|---|---|
| ∘ | Use semantic search and AI to recommend modification to an |
| | existing STC maturity model or create a new model. |
| ∘ | Using the STC Maturity Model to assess an organization's |
| | existing security posture, identifying: |

| | |
|---|---|
| > | Gaps in built-in security defenses at both the individual |
| | STC level and across the security portfolio. |
| > | Opportunities for security improvement & technology |
| | enhancements. |
| > | Required security investments & automation |
| | opportunities for defense maturity. |

| | |
|---|---|
| (c) | An AI-driven method for categorizing and ranking security tools |

within the STC framework, comprising:

| | |
|---|---|
| ∘ | AI-driven determination & mapping of security tools to STCs, |
| | based on: |

| | |
|---|---|
| > | Tool Functions & features and best-fit STCs. |
| > | Use semantic search and AI to ensure a highly accurate |
| | tool to STC mapping. |

| | |
|---|---|
| ∘ | AI-driven ranking of security tools into multiple tiers, where: |

| | |
|---|---|
| > | T1 (Primary Tools): Highest-ranked tools based on |
| | functionality, effectiveness, and cost efficiency. |
| > | T2 (Secondary Tools): Tools with moderate |
| | effectiveness or overlapping functionality with T1 |
| | tools. |
| > | T3 (Redundant or Obsolete Tools): Low-value tools |
| | that should be retired or consolidated. |

| | |
|---|---|
| ∘ | Applying tiered ranking to resolve tool duplication, optimize |
| | security investment, and streamline security architecture. |

| | |
|---|---|
| (d) | A method for using the STC Matrix to provide a cohesive view of |

risks, gaps, and opportunities across the security portfolio, comprising:

| | |
|---|---|
| ∘ | Structuring security data in an STC Matrix, where each STC is |
| | correlated to: |

| | |
|---|---|
| > | Security risks and mitigation strategies. |
| > | Security technologies & issues. |
| > | Security maturity benchmarks and gaps. |

| | |
|---|---|
| ∘ | Generating an STC Matrix output to visualize: |

| | |
|---|---|
| > | Security gaps at the capability and technology levels. |
| > | Risk clusters and high-priority mitigation areas. |
| > | Portfolio-wide risks, gaps, & optimization |
| | opportunities. |

| | |
|---|---|
| (e) | A Method to Categorize Security Elements Using the STC Framework |

| | |
|---|---|
| ∘ | AI-driven determination of mapping between security tools to |
| | STCs based on functional coverage, security objectives, and |
| | compliance alignment. |
| ∘ | AI-driven determination of mapping between compliance |
| | controls, framework components, security risks, and mitigation |
| | controls to corresponding STCs. |

| | |
|---|---|
| (f) | A method for ranking and prioritizing risk mitigation controls based on |

risk reduction effectiveness and cost/Level of effort (LOE),
comprising:

| | |
|---|---|
| ∘ | Assessing each risk mitigation control based on: |

| | |
|---|---|
| > | Potential risk reduction impact. |
| > | Cost, Level of effort (LOE) & implementation |
| | complexity. |

| | |
|---|---|
| ∘ | Prioritizing mitigation controls into four levels (P0-P3): |

| | |
|---|---|
| > | P0 - Critical, Immediate Action (High impact, low |
| | cost/effort). |
| > | P1 - High Priority (High impact, moderate cost/effort). |
| > | P2 - Medium Priority (Moderate impact, moderate-to- |
| | high cost/effort). |
| > | P3 - Low Priority (Low impact, high cost/effort). |

| | |
|---|---|
| ∘ | Using AI-driven analysis to optimize mitigation control |
| | selection based on an organization's security objectives and |
| | budget constraints. |

| • | Aspect 13: AI-driven system to perform security tools rationalization, the | |
|---|---|---|
| | system comprising: | |
| | (a) | An Offline Process, wherein the system periodically: |

| | |
|---|---|
| ∘ | Ingests security tool metadata from multiple sources (e.g., |
| | vendor websites, APIs), |
| ∘ | Applies semantic search & AI adjudication to map tools to |
| | STCs and compliance controls accurately, and |
| ∘ | Stores precomputed mappings in a database for real-time |
| | analysis. |

| | |
|---|---|
| (b) | An Online Tool Mapping Process, wherein the system: |

| | |
|---|---|
| ∘ | Receives uploaded security tool set, |
| ∘ | Normalizes tool names and cross-references the uploaded data |
| | with precomputed mappings, and |
| ∘ | Assigns each tool to an STC, wherein tools without existing |
| | mappings are dynamically classified using semantic matching |
| | and AI adjudication. |

| | |
|---|---|
| (c) | A multi-Level Analysis Engine, designed to: |

| | |
|---|---|
| ∘ | Perform tool-level analysis within each STC by evaluating |
| | tools' functional coverage, redundancy, and cost efficiency, |
| ∘ | Assess security capability maturity within each STC using a |
| | predefined STC maturity model, and |
| ∘ | Classify risks to STC matrix to determine risk clusters, and |
| ∘ | Aggregate analysis results into an interactive Portfollo X-Ray |
| | of security assessment that provides a real-time view of |
| | security risks, gaps, and optimization opportunities. |

| | |
|---|---|
| (d) | A Continuous Update Module, wherein the system automatically: |

| | |
|---|---|
| ∘ | Obtain new security technologies & updates, |
| ∘ | Dynamically update tool databases & STC mapping. |

| • | Aspect 14: An AI-driven system for dynamically generating, reviewing, and | |
|---|---|---|
| | updating Security Technology Capability (STC) definitions, the system | |
| | comprising: | |
| | (a) | An STC Definition Engine designed to generate and update STC |
| | | definitions, including their purpose, functionality, scope, and |
| | | description, based on evolving security technologies and industry |
| | | standards. |
| | (b) | A Semantic Search Module designed to identify impacted STCs by |
| | | analyzing changes in security tool features, industry trends, public |
| | | security frameworks, and regulatory controls, and forwarding detected |
| | | changes to the AI-Powered Adjudication Module. |
| | (c) | An AI-Powered Adjudication Module configured to: |

| | |
|---|---|
| ∘ | Evaluate changes from the Semantic Search Module, |
| ∘ | Determine necessary STC updates or realignments, and |
| ∘ | Provide STC modification recommendations. |

| (d) | A Versioning and Governance Module configured to track historical |
|---|---|
| | STC changes, security tool mappings, and compliance alignments, |
| | ensuring auditability. |
| (e) | A Continuous Update Mechanism that ingests security research, |

regulatory updates, and tool changes to trigger AI-driven STC
modifications.

| • | Aspect 15: A system for dynamically defining, reviewing, and updating the | |
|---|---|---|
| | Security Technology Capability (STC) maturity model in a multi-cloud or | |
| | hybrid-cloud computing environment, the system comprising: | |
| | (a) | Semantic search to identify relevant SCF controls for an STC, gathers |
| | | associated controls and their CMMI data, and forwards this information |
| | | to the AI Assistant for synthesizing an STC-specific maturity |
| | | definition. |
| | (b) | An AI Assistant that processes the STC definition evaluates mapped |
| | | security controls and their CMMI definitions and generates a maturity |
| | | model for the STC, including security functions, objectives, and |
| | | performance metrics for the STC. |
| | (c) | A Versioning and Governance System that maintains historical versions |
| | | of STC maturity model, ensuring continuous updates and compliance |
| | | with evolving security standards. |

| • | Aspect 16: A system for dynamically mapping compliance controls from | |
|---|---|---|
| | compliance regulations and public frameworks (e.g., SCF) to Security | |
| | Technology Capabilities (STCs), the system comprising: | |
| | (a) | Identify changed compliance controls from compliance regulations |
| | | (e.g., NIST 800-53) or security framework (e.g., SCF). |
| | (b) | Use semantic search to find the most relevant STCs for the regulatory |
| | | control or framework component. |
| | (c) | An AI-Powered Adjudication Module designed to: |

| | |
|---|---|
| ∘ | Evaluate relevant data from semantic search, |
| ∘ | Determine the final mapping between compliance controls, |
| | framework components, and STCs. |

| | (d) | Continuous Compliance Mapping Engine to detect changes in |
|---|---|---|
| | | regulations, security frameworks, and STC definitions and adjust the |
| | | mapping between them. |
| | (e) | A Compliance Versioning and Retrieval System configured to |
| | | maintain historical compliance mappings, version tracking, and audit |
| | | logs for regulatory assessments. |
| • | Aspect 17: AI-driven system for recommending security tools to close | |
| | Security Technology Capability (STC) gaps, the system comprising: | |
| | (a) | Semantic search to identify candidate security tools for resolving one |

or more of the following STC gaps:

| | |
|---|---|
| ∘ | Absence of a security tool for an STC (e.g., no anti-virus or |
| | EDR tool in Endpoint Protection, Detection, and Response |
| | STC), |
| ∘ | Partial functional coverage within an STC (e.g., multiple |
| | authentication tools exist but none provide risk-adjusted |
| | authentication), and |
| ∘ | Maturity-level deficiencies within an STC (e.g., an anti-virus |
| | tool detects known viruses but lacks zero-day detection using |
| | ML). |

| | |
|---|---|
| (b) | An AI-Driven Tool Evaluation Module that: |

| | |
|---|---|
| ∘ | Assesses candidate tools based on functional coverage, |
| | effectiveness in closing the gap, cost, and organization-specific |
| | criteria, |
| ∘ | Determines the optimal tool or combination of tools to close |
| | the identified STC gap, and |
| ∘ | Ranks recommendations based on organization-defined |
| | selection priorities. |

| | |
|---|---|
| (c) | Continuous Update Engine that: |

| | |
|---|---|
| ∘ | Ingests new security tool data, including emerging threats and |
| | evolving compliance requirements, and |
| ∘ | Continuously refine AI-driven tool recommendations based on |
| | real-time security needs. |

| • | Aspect 18: AI-driven system for analyzing security risks, generating prioritize | |
|---|---|---|
| | risk mitigation controls, and recommending security tools to implement the | |
| | generated controls in a multi-cloud or hybrid-cloud computing environment, | |
| | the system comprising: | |
| | (a) | An AI-Powered Risk Mitigation Control Module that: |

| | |
|---|---|
| ∘ | Analyzes each security risk, |
| ∘ | Decompose the risk into organized actionable risk components, |
| ∘ | Generates prioritized risk mitigation controls based on risk |
| | reduction effectiveness, cost, and implementation effort. |

| (b) | A Security Tool Candidate Module that uses semantic search to |
|---|---|
| | identify the most suitable security tools capable of implementing AI- |
| | generated risk mitigation controls. |
| (c) | An AI-Driven Tool Ranking Module that: |

| | |
|---|---|
| ∘ | Evaluates and ranks security tools based on: |

| | |
|---|---|
| > | Risk reduction effectiveness, |
| > | Cost and implementation effort, and |
| > | Compatibility with must-have security tools, |

| | |
|---|---|
| ∘ | Dynamically adjusts recommendations based on organization- |
| | specific priorities, |
| ∘ | Generates AI-driven explanations for tool rankings to enhance |
| | transparency. |

| | |
|---|---|
| • | Aspect 19: AI-driven system for analyzing security risks & mitigation controls |
| | and mapping them to Security Technology Capabilities (STCs), the system |
| | comprising: |

| | |
|---|---|
| (a) | An Risk & Control Mapping Module that: |

| | |
|---|---|
| ∘ | Dynamically analyzes a security risk, risk component, or |
| | mitigation controls for the risk, |
| ∘ | Use semantic search to locate candidate STCs, |
| ∘ | Use AI to adjudicate the proper mapping between risks, |
| | mitigation controls, and STCs. |

| | |
|---|---|
| (b) | A Portfollo Risk Analysis Engine that: |

| | |
|---|---|
| ∘ | Aggregates and quantifies risk across multiple STCs, |
| ∘ | Grouping risks into clusters & determining high risk clusters, |
| ∘ | Prioritizing risk mitigation based on AI-driven cost-benefit |
| | analysis, |
| ∘ | Determines overall risk exposure across the organization's |
| | security portfolio. |

| | |
|---|---|
| (c) | A Visualization and Insights Module that generates a risk heat map, |

| providing: | |
|---|---|
| ∘ | A real-time aggregated view of risk distribution across STCs, |
| | and |
| ∘ | Actionable insights to prioritize risk mitigation efforts. |

| • | Aspect 20: AI-Driven System for Mapping Security Tools and Technology | |
|---|---|---|
| | Trends to Security Technology Capabilities (STCs) comprising a system for | |
| | dynamically mapping security tools and emerging security technologies to | |
| | Security Technology Capabilities (STCs), the system comprising: | |
| | (a) | AI-Driven Security Tool Mapping: |

| | |
|---|---|
| ∘ | Receiving security tool data from multiple sources, including |
| | vendor databases, API integrations, security catalogs, and |
| | enterprise asset inventories. |
| ∘ | Using semantic search and AI adjudication to map security |
| | tools to the most relevant STCs based on: |

| | |
|---|---|
| > | Tool functionality and feature set, |
| > | STC scope and definitions, |

| | |
|---|---|
| (b) | AI-Driven Security Technology Trend Mapping: |

| | |
|---|---|
| ∘ | Ingesting security technology trends from public research, |
| | vendor whitepapers, industry reports, and security framework |
| | updates, |
| ∘ | Breaking a major trend down into its components, |
| ∘ | Identifying emerging technologies, key functions, and features, |
| ∘ | Using semantic search and AI adjudication to map security |
| | trends or micro-trends to STCs. |
| ∘ | Recommending updates to STC definitions based on the |
| | evolution of security tools and technologies. |

| | |
|---|---|
| (c) | AI-Driven Continuous Update and Refinement Module: |

| | |
|---|---|
| ∘ | Periodically updating the security tool-to-STC mapping as new |
| | security tools emerge or existing tools evolve. |
| ∘ | Dynamically adjusting STC definitions based on industry |
| | trends and changes in cybersecurity best practices. |
| ∘ | Using AI-assisted adjudication to refine mappings and ensure |
| | alignment with evolving security architectures. |

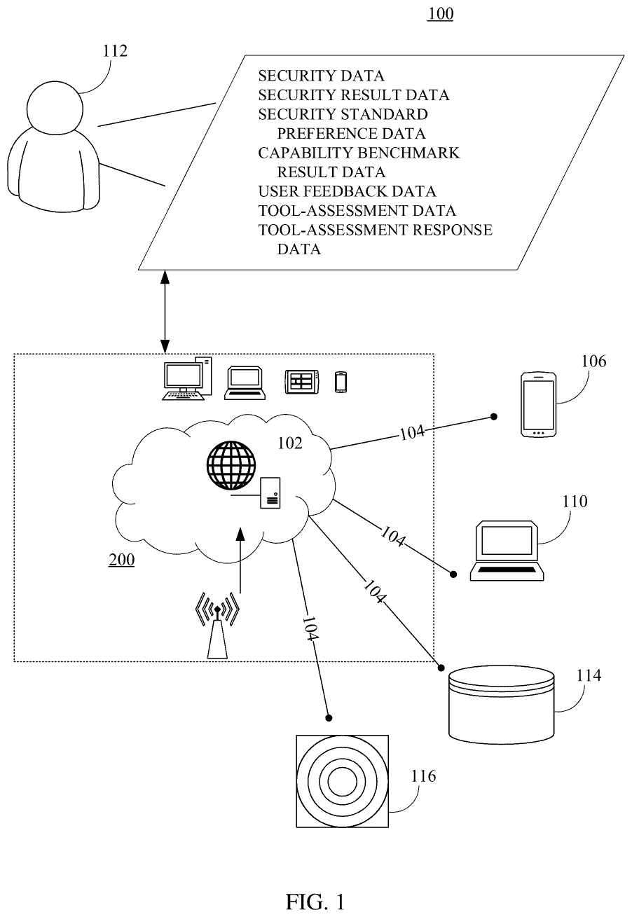

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

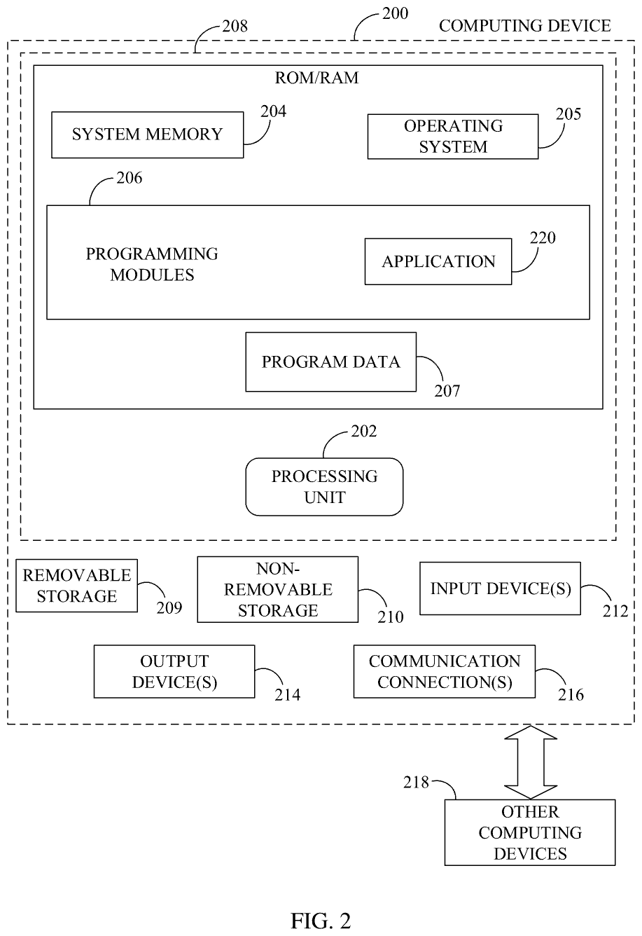

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include an image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

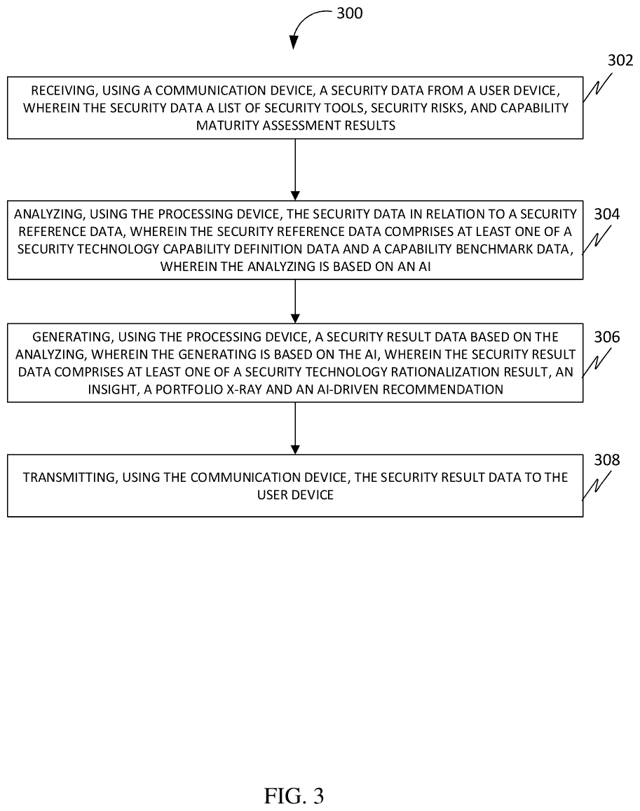

FIG. 3 illustrates a flowchart of a method 300 of facilitating security technology rationalization, in accordance with some embodiments.

Accordingly, the method 300 may include a step 302 of receiving, using a communication device 902, a security data from a user device. The communication device 902 is the primary interface for receiving, transmitting, and processing security data across the STR platform. It enables the seamless exchange of information between user devices, cloud infrastructure, and AI-driven STR components. The communication device 902 is responsible for:
Receiving security tool data from user devices and transmitting it for analysis;
Facilitating real-time updates between the processing device 904 and ai-driven analysis engines;
Interacting with external api-based ai automation tools for enhanced decision-making; and
Supporting offline processes by storing and forwarding data for asynchronous batch processing.

Further, the security data comprises a list of security tools, a list of security risks, and capability maturity assessment results. Further, the method 300 may include a step 304 of analyzing, using the processing device 904, the capability data with a security reference data. Further, the security reference data includes a reference capability. Further, the method 300 may include a step 306 of generating, using the processing device 904, a security result data based on the analyzing. The security result data includes an interactive Portfolio X-Ray, which aggregates results from the Tool Assay, STC Maturity Assessment, and Risk-to-STC Mapping to identify risk clusters and prioritize mitigation strategies. Further, the generating may be based on an AI & semantic search. Further, the security result data represents a cybersecurity posture of the organization. Further, the method 300 may include a step 308 of transmitting, using the communication device 902, the security result data to the user device.

In some embodiments, the security result data may include an interactive portfolio X-ray. Further, the portfolio x-ray aggregates result from one or more of a tool assay, a security technology capability maturity assessment, and a risk-to-security technology capability mapping to identify risk clusters and prioritize mitigation strategies.

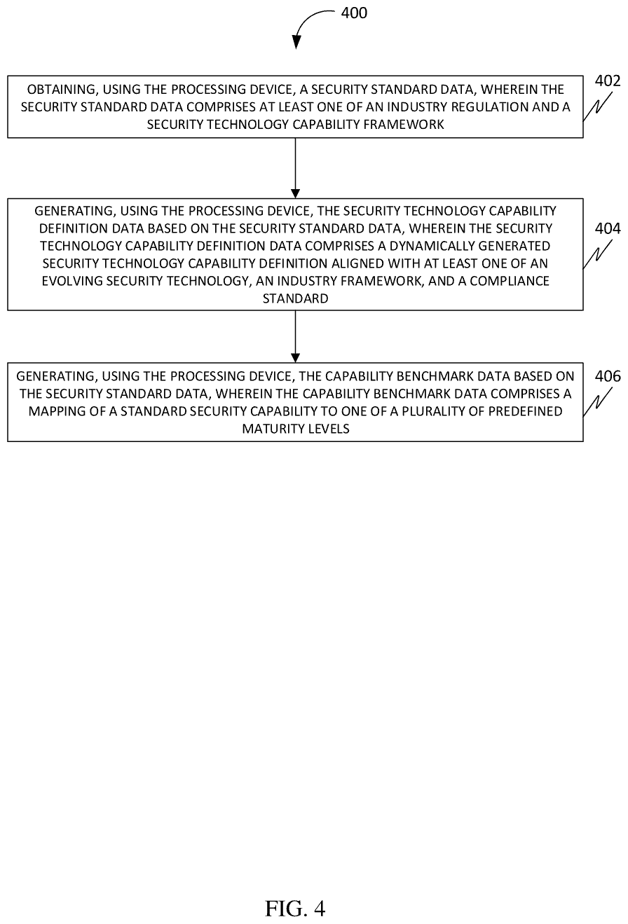

FIG. 4 illustrates a flowchart of a method 400 of facilitating security technology rationalization including generating, using the processing device 904, a capability benchmark data, in accordance with some embodiments.

Further, in some embodiments, the method 400 further may include a step 402 of obtaining, using the processing device 904, a security standard data. Further, the security standard data includes one or more of an industry regulation and a security technology capability framework. Further, in some embodiments, the method 400 further may include a step 404 of generating, using the processing device 904, the security technology capability definition data based on the security standard data. Further, the security technology capability definition data includes a dynamically generated security technology capability definition aligned with one or more of an evolving security technology, an industry framework, and a compliance standard. Further, in some embodiments, the method 400 further may include a step 406 of generating, using the processing device 904, the capability benchmark data based on the security standard data. Further, the capability benchmark data includes a mapping of a standard security capability to one of two or more predefined maturity levels.

In some embodiments, the method 400 may further include receiving, using the communication data, a security standard preference data from the user device. Further, the security standard preference data represents a preferred information technology security standard. Further, the obtaining of the security standard data may be further based on the security standard preference data.

In some embodiments, the method 400 may further include extracting, using the processing device 904, a function data based on the standard security data. Further, the function data includes a technology function associated with the information technology security standard. Further, the generating of one or more of the security technology capability definition data and the capability benchmark data may be further based on the function data.

In some embodiments, the method 400 may further include generating, using the processing device 904, a matrix data based on each of the function data and the capability data. Further, the matrix data represents a correlation of the technical capability with each of the technology function and a security domain. Further, generating of the security result data may be further based on the matrix data.

In some embodiments, the method 400 may further include generating, using the processing device 904, a benchmark enhancement data. Further, the benchmark enhancement data includes one or more of an advanced security technology and a countermeasure of a security risk. Further, the generating of the capability benchmark data may be further based on the benchmark enhancement data.

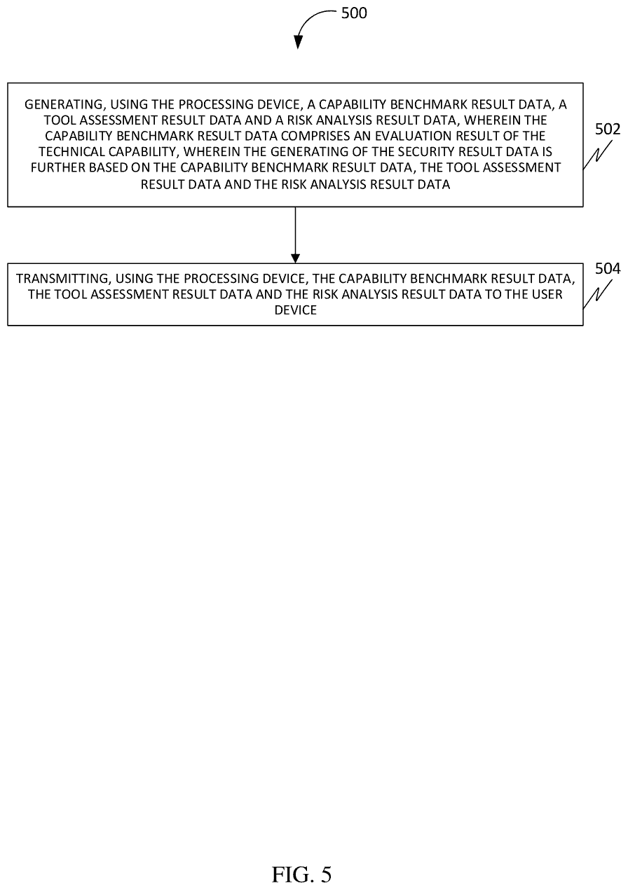

FIG. 5 illustrates a flowchart of a method 500 of facilitating security technology rationalization including generating, using the processing device 904, a capability benchmark result data, in accordance with some embodiments.

Further, in some embodiments, the method 500 further may include a step 502 of generating, using the processing device 904, a capability benchmark result data, a tool assessment result data and a risk analysis result data based on the analyzing. Further, the capability benchmark result data includes an evaluation result of the technical capability. Further, the generating of the security result data may be further based on the capability benchmark result data, the tool assessment result data and the risk analysis result data. Further, in some embodiments, the method 500 further may include a step 504 of transmitting, using the processing device 904, the capability benchmark result data, the tool assessment result data and the risk analysis result data to the user device.

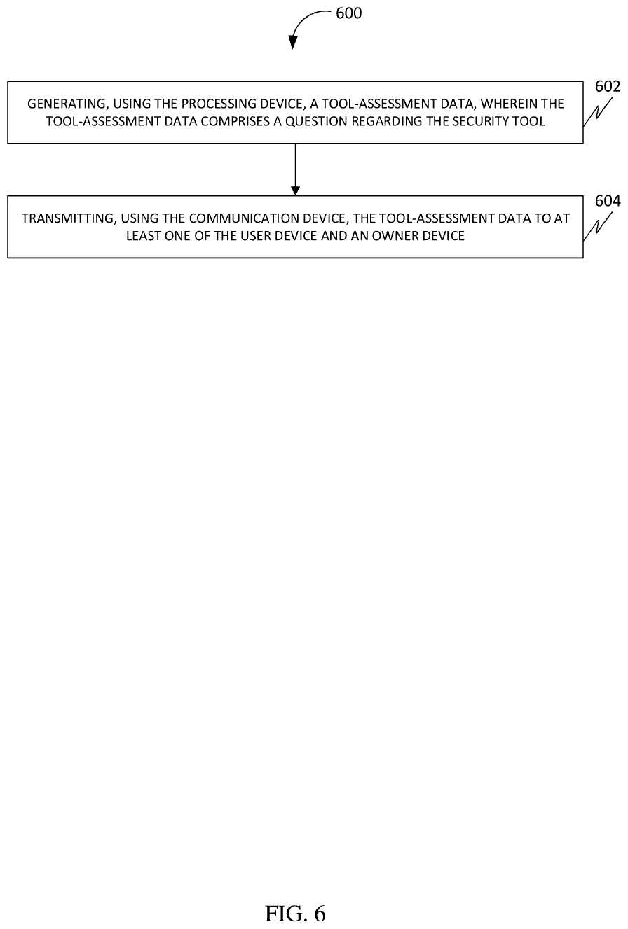

FIG. 6 illustrates a flowchart of a method 600 of facilitating security technology rationalization including generating, using the processing device 904, a tool-assessment data, in accordance with some embodiments.

Further, in some embodiments, the method 600 further may include a step 602 of generating, using the processing device 904, a tool-assessment data. Further, the tool-assessment data includes a question regarding the security tool. Further, in some embodiments, the method 600 further may include a step 604 of transmitting, using the communication device 902, the tool-assessment data to one or more of the user device and an owner device.

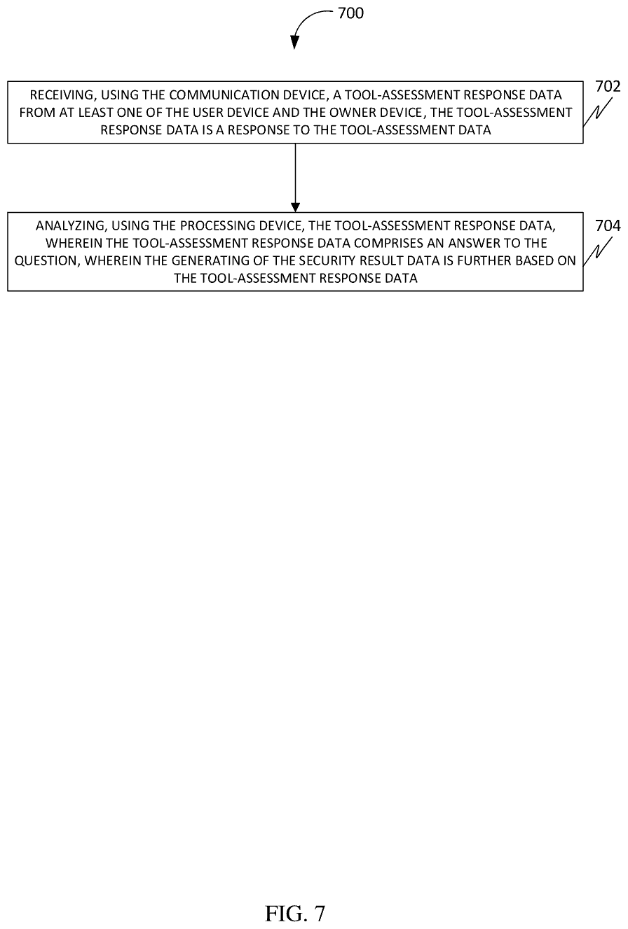

FIG. 7 illustrates a flowchart of a method 700 of facilitating security technology rationalization including analyzing, using the processing device 904, the tool-assessment response data, in accordance with some embodiments.

Further, in some embodiments, the method 700 further may include a step 702 of receiving, using the communication device 902, a tool-assessment response data from one or more of the user device and the owner device, the tool-assessment response data may be a response to the tool-assessment data. Further, in some embodiments, the method 700 further may include a step 704 of analyzing, using the processing device 904, the tool-assessment response data. Further, the tool-assessment response data includes an answer to the question. Further, the generating of the security result data may be further based on the tool-assessment response data.

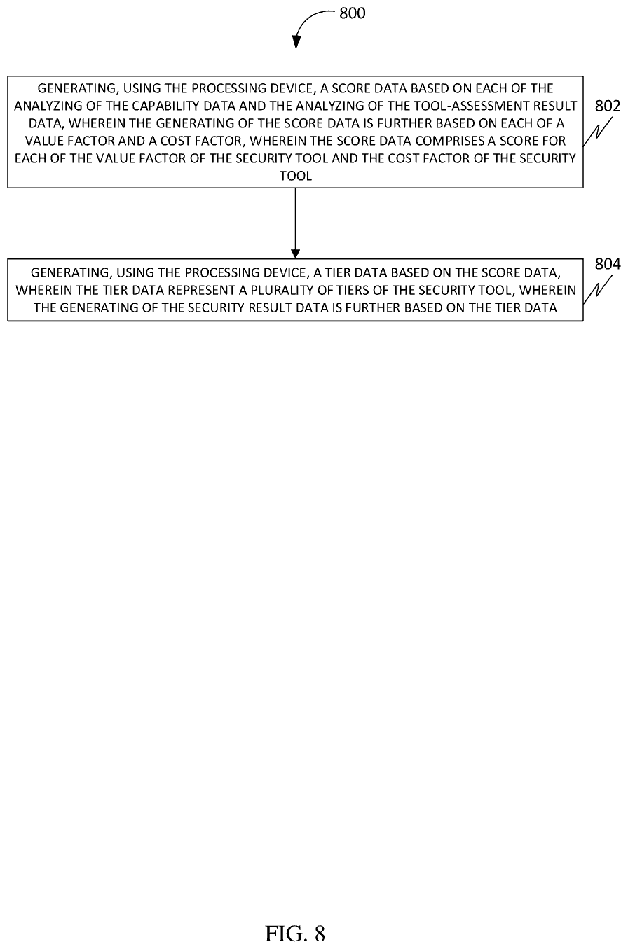

FIG. 8 illustrates a flowchart of a method 800 of facilitating security technology rationalization including generating, using the processing device 904, a tier data, in accordance with some embodiments.

Further, in some embodiments, the method 800 further may include a step 802 of generating, using the processing device 904, a score data based on each of the analyzing of the capability data and the analyzing of the tool-assessment result data. Further, the generating of the score data may be further based on each of a value factor and a cost factor. Further, the score data includes a score for each of the value factor of the security tool and the cost factor of the security tool. Further, in some embodiments, the method 800 further may include a step 804 of generating, using the processing device 904, a tier data based on the score data. The tier data represents a categorization of the security tool into three tiers (T1, T2, T3) based on a structured percentile analysis of security tools across eight value dimensions and three cost factors, computed using AI-based ranking models. Further, the tier data represent a category of the security tool. Further, the generating of the security result data may be further based on the tier data.

In some embodiments, the tier data represents a categorization of the security tool into three tiers (T1, T2, T3) based on a structured percentile analysis of security tools across eight value dimensions and three cost factors, computed using AI-based ranking models.

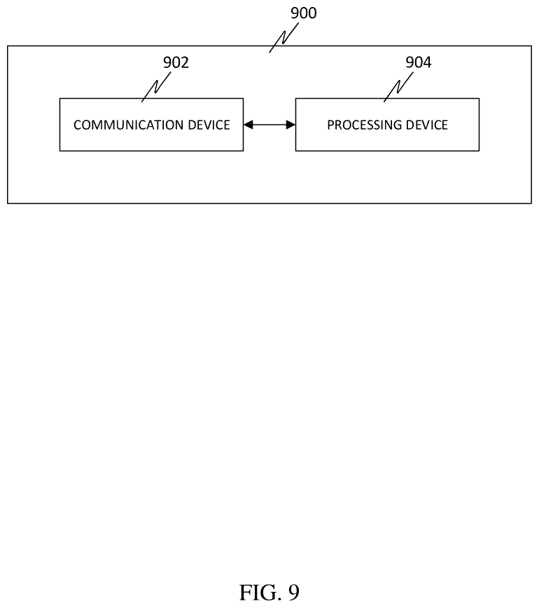

FIG. 9 illustrates a block diagram of a system 900 of facilitating security technology rationalization, in accordance with some embodiments.

Accordingly, the system 900 may include a communication device 902. Further, the communication device 902 may be configured for receiving a security data from a user device. Further, the security data comprises a list of security tools, a list of security risks, and capability maturity assessment results. Further, the communication device 902 may be configured for transmitting a security result data to the user device. Further, the system may include a processing device 904. Further, the system 900 may include a processing device 904. Further, the processing device 904 may be configured for determining a capability data based on the security data. Further, the capability data includes a technical capability corresponding to one or more of the security tool and the security target. Further, the processing device 904 may be configured for analyzing the capability data in relation to a security reference data. Further, the security reference data includes one or more of a security technology capability definition data and a capability benchmark data. Further, the analyzing may be based on an AI. Further. Further, the processing device 904 may be configured for generating the security result data based on the analyzing. Further, the generating may be based on the AI. Further, the security result data includes one or more of a security technology rationalization result, an insight, a portfolio X-ray and an AI-driven recommendation.

Further, in some embodiments, the processing device 904 may be configured for obtaining security standard data. Further, the security standard data includes one or more of an industry regulation and a security technology capability framework. Further, the processing device 904 may be configured for generating the security technology capability definition data based on the security standard data. Further, the security technology capability definition data includes a dynamically generated security technology capability definition aligned with one or more of an evolving security technology, an industry framework, and a compliance standard. Further, the processing device 904 may be configured for generating the capability benchmark data based on the security standard data. Further, the capability benchmark data includes a mapping of a standard security capability to one of two or more predefined maturity levels.

In some embodiments, the communication device 902 may be further configured for receiving a security standard preference data from the user device. Further, the security standard preference data represents a preferred information technology security standard. Further, the obtaining of the security standard data may be further based on the security standard preference data.

In some embodiments, the processing device 904 may be further configured for extracting a function data based on the standard security data. Further, the function data includes a technology function associated with the information technology security standard. Further, the generating of one or more of the security technology capability definition data and the capability benchmark data may be further based on the function data.

In some embodiments, the processing device 904 may be further configured for generating a matrix data based on each of the function data and the capability data. Further, the matrix data represents a correlation of the technical capability with each of the technology function and a security domain. Further, generating of the security result data may be further based on the matrix data.

In some embodiments, the processing device 904 may be further configured for generating a benchmark enhancement data. Further, the benchmark enhancement data includes one or more of an advanced security technology and a countermeasure of a security risk. Further, the generating of the capability benchmark data may be further based on the benchmark enhancement data.

In some embodiments, the processing device 904 may be further configured for generating a capability benchmark result data based on the analyzing. Further, the capability benchmark result data includes an evaluation result of the technical capability. Further, the generating of the security result data may be further based on the capability benchmark result data. Further, the communication device 902 may be further based on the transmitting the capability benchmark result data to the user device.

In some embodiments, the processing device 904 may be further configured for generating a tool-assessment data. Further, the tool-assessment data includes a question regarding the security tool. Further, the communication device 902 may be further configured for transmitting the tool-assessment data to one or more of the user device and an owner device.

In some embodiments, the communication device 902 may be further configured for receiving a tool-assessment response data from one or more of the user device and the owner device, the tool-assessment response data may be a response to the tool-assessment data. Further, the processing device 904 may be further configured for analyzing the tool-assessment response data. Further, the tool-assessment response data includes an answer to the question. Further, the generating of the security result data may be further based on the tool-assessment response data.

Further, in some embodiments, the processing device 904 may be further configured for generating a score data based on each of the analyzing of the capability data and the analyzing of the tool-assessment result data. Further, the generating of the score data may be further based on each of a value factor and a cost factor. Further, the score data includes a score for each of the value factor of the security tool and the cost factor of the security tool. Further, the processing device 904 may be further configured for generating tier data based on the score data. Further, the tier data represent a category of the security tool. Further, the generating of the security result data may be further based on the tier data.

In some embodiments, the tier data represents a categorization of the security tool into three tiers (T1, T2, T3) based on a structured percentile analysis of security tools across eight value dimensions and three cost factors, computed using AI-based ranking models.

In some embodiments, the security data comprises one or more of a list of security tools, a list of security risks and a capability maturity assessment result.

In some embodiments, the analyzing of the capability data comprises evaluating one or more of a security technology gap, an issue and a risk exposure across the security portfolio.

In some embodiments, the analyzing of the capability data comprises determining one or more of a capability maturity deficiency and a recommendation to close a gap.

In some embodiments, the analyzing of the capability data comprises determining one or more of a risk cluster and a prioritize risk mitigation strategy.

In some embodiments, the analyzing of the capability data comprises identifying an optimization opportunity for one or more of the security tool, a security technology capability maturity and a cost efficiency.

In some embodiments, the security technology rationalization result and the insight comprises AI-driven findings on one or more of a tool-level issue, a capability maturity and a risk cluster.

In some embodiments, the portfolio x-ray comprises a set of interactive visualization summarizing one or more of a security posture, a tool redundancy, a risk cluster and a capability maturity gap.

In some embodiments, the AI-driven recommendation comprises an optimized strategy for one or more of a risk reduction, a maturity improvement, a tool rationalization and a cost efficiency.

In some embodiments, the security result data comprises a mitigation control data, wherein the mitigation control data comprises an actionable mitigation control to resolve a risk associated with the security tool.

In some embodiments, the security result data comprises a plurality of mitigation control data with ranking. Further, the ranking is based on each of a risk reduction potential and a level of effort and cost needed to resolve the risk.

In some embodiments, the ranking is based on a scale of P0, P1, P2 and P3. Further, the P0 represents the actionable mitigation control with very high risk reduction potential and at least one of a low level of effort and low cost. Further, the P3 represents the actionable mitigation control with very low risk reduction potential, very high level of effort and a very high cost.

In some embodiments, the analyzing of the security data is further based on evolving security technology and a security standard.

In some embodiments, the AI is configured to update the reference capability based on changes in the information technology security standard.

In some embodiments, the security tool may be configured to protect two or more data of the organization from a malicious activity. Further, the security tool includes one or more of a software and a hardware.

In some embodiments, the cybersecurity posture corresponds to a security status of an information technology network associated with the organization.

In some embodiments, the security result data represents a maturity level of the technical capability corresponding to one or more of the security tool and the security target.

In some embodiments, the security result data represent a maturity gap between a maturity levels of current security and the target security.

In some embodiments, the security data may include a security tool metadata.

In some embodiments, the two or more maturity levels represent an effectiveness of implementing the standard technical capability in the organization.

In some embodiments, the two or more maturity levels include each of a first level, a second level, a third level, a fourth level and a fifth level.

In some embodiments, the first level corresponds to an ad-hoc security. Further, the second level corresponds to a compliance driven security. Further, the third level corresponds to an enterprise-wide standardized security. Further, the fourth level corresponds to a quantitatively controlled security. Further, the fifth level corresponds to a continuously improving security based on quantitative data in real time.

In some embodiments, the security risk includes one of two or more cloud security risks.

In some embodiments, the two or more cloud security risks include top cloud security risk.

In some embodiments, the security risk includes one of two or more web application security risks.

In some embodiments, the two or more web application securities includes an open web application security project top ten.

In some embodiments, the security risk includes two or more security risks identified by SysAdmin, Audit, Network and Security institute.

In some embodiments, the information technology security standard includes a Federal Financial Institutions Examination Council standard.

In some embodiments, the information technology security standard includes a Critical Security Control standard.

In some embodiments, the information technology security standard includes a National Institute of Standard and Technology Cybersecurity Framework standard.

In some embodiments, the information technology security standard includes a Capability Maturity Model Integration standard.

In some embodiments, the information technology security standard includes a Security Control Framework standard.

In some embodiments, the information technology security standard includes a Service Organization Control standard.

In some embodiments, the information technology security standard includes a Payment Card Industry standard.

In some embodiments, the information technology security standard includes an International Organization for Standardization 27001 standard.

In some embodiments, the capability benchmark data includes a meta-framework comprising two or more control frameworks. Further, each of the two or more control frameworks may be associated with one or more standard technical capabilities based on two or more information technology security standards.

In some embodiments, the matrix data includes a two-dimensional matrix. Further, a row of the two-dimensional matrix and a column of the two-dimensional matrix represents the security domain and the technology function respectively. Further, the two-dimensional matrix includes a block representing the technical capability correlated with each of the technology function and the security domain.

In some embodiments, the information technology security standard includes National Institute of Standard and Technology Cybersecurity Framework standard. Further, the technology functional includes one or more of an identification, a protection, a detection, a responding and a recovering.

In some embodiments, the security domain includes one or more of an identity management, an access management, a computer security, an application security, a data security, a network security, a threat management, a vulnerability management, a security operation, a governance risk, a governance compliance, and a financial fraud management.

In some embodiments, the security result data includes a portfolio X-ray, may. Further, the portfolio X-ray correlates a cybersecurity capability of the organization with a monetary value invested for the technical capability.

In some embodiments, the portfolio X-ray includes a visual representation of a state of the cybersecurity of the organization.

In some embodiments, the portfolio X-ray further represents one or more of a capability inefficiency and an area of security improvement.

In some embodiments, the generating of the matrix data may be further based on the AI.

In some embodiments, the analyzing of the capability data includes identifying one or more of a security risk and a capability improvement opportunity.

In some embodiments, the security result data includes one or more of a recommendation and a strategy to improve a security of the organization.

In some embodiments, the analyzing of tool-assessment response data comprises identifying at least one of a security tool redundancy, a cost inefficiency and a security tool gap.

In some embodiments, the recommendation corresponds to one or more of an upgrading of the security tool and an implementing a new security tool for the technical capability.

In some embodiments, the recommendation corresponds to an implementing of a new technical capability to achieve a specific security function.

In some embodiments, one or more of the recommendation and the strategy reduces one or more of a security risk of the organization and an investment on the security tool.

In some embodiments, the recommendation includes a countermeasure for a security risk associated with one or more of the security tool and the security target.

In some embodiments, the method 300 may further include receiving, using the communication data, user feedback data from the user device. Further, the user feedback data includes a feedback representing effectiveness of the security result data. Further, the AI may be configured to generate a second security result data based on the feedback data.

In some embodiments, the security tool may be configured to protect one or more of a hybrid-cloud environment of the organization and a multi-cloud environment of the organization.

In some embodiments, the user device may be associated with a user. Further, the user corresponds to a stakeholder of the organization.

In some embodiments, the security result data includes one or more of a preliminary portfolio X-ray and a portfolio X-ray.

In some embodiments, the preliminary portfolio X-ray includes an overview of cybersecurity posture.

In some embodiments, the portfolio X-ray includes a detailed cybersecurity posture by summarizing one or more of security risk, a capability gap and a security-tool issue.

In some embodiments, the capability benchmark result data includes a maturity model representing a maturity level of the technical capability.

In some embodiments, the user device may be associated with a user corresponding to a stakeholder of the organization. Further, the owner device may be associate with an owner of the security tool.

In some embodiments, the question may be related to one or more of an operating cost, an initial cost, a license utilization, a disposition of the security tool, a usage of the tool and a performance of the tool.

In some embodiments, the analyzing of the tool-assessment response data includes identifying one or more of a technology gap, a capability overlap, and a cost inefficiency.

In some embodiments, the capability overlap represents a performance of the technical capability by two or more security tools.

In some embodiments, the security tool may be associated with two or more capabilities.

In some embodiments, the security result data includes a heat map representing the cybersecurity posture.

In some embodiments, the security result data includes one or more of a radar chat and a pie chart representing the cybersecurity posture of the organization.

In some embodiments, the method 800 may further include transmitting, using the communication device 902, the tier data to the user device. Further, the category represents an effectiveness of the security tool.

In some embodiments, the security result data includes a strategic recommendation. Further, the strategic recommendation may be further based on the category.

In some embodiments, the category may be comprised in two or more categories comprising one or more of a tier-1 category, a tier-2 category and a tier-3 category.

In some embodiments, the tier-1 category represents a most effective security tool with lowest cost. Further, the strategic recommendation indicates a continuous use of the most effective security tool.

In some embodiments, the tier-2 category represents a security tool providing a moderate value with a moderate cost. Further, the strategic recommendation indicates a migration to a better security tool with a same value of the moderate cost.

In some embodiments, the tier-3 category represents a least effective security tool with high cost. Further, the strategic recommendation indicates a replacement of the least effective security tool with a cost-effective security tool.

In some embodiments, the score may be on a scale of one to ten.

In some embodiments, the value factor includes two or more value factors comprising one or more of an ability to provide the functions required at a selected maturity level, a usability and manageability, an integration and compatibility, a performance, a scalability, a cloud support, a vendor support and a maturity and completeness of operational processes.

In some embodiments, the cost factor includes one or more of a subscription and license cost, a level of effort to implement and a support and maintenance cost.

In some embodiments, the method 300 may further include obtaining, using the processing device 904, a tool data based on the security data. Further, the tool data includes two or more details related to the security tool. Further, the determining of the capability data may be further based on the tool data.

In some embodiments, the security result data represents a comparison between a current state cybersecurity posture of the organization and a targeted state cybersecurity posture of the organization.

FIG. 10 is an illustration of a portfolio X-ray, in accordance with some embodiments. Further, the portfolio X-ray depicts an overall gap, risks, opportunities of an organization's cybersecurity capabilities and capital spending.

FIG. 11 is an illustration of security technology capability matrix, in accordance with some embodiments. Further, the security technology capability matrix aligns the NIST Cyber Security Framework (CSF) functions and security domains in a two-dimensional matrix.

FIG. 12 is an illustration of security result data, in accordance with some embodiments. Further, the security result data depicts capability assessment result.

FIG. 13 is an illustration of a cost-value tier, in accordance with some embodiments. Further, T1 tools offer the most value to an organization with the lowest cost. Further, the T3 tools have an opposite characteristic. The recommendation will be to keep T1 tools, strategically retire T3 tools, and migrate T2 tools as opportunities arise.

FIG. 14A and FIG. 14B are an illustration of system architecture for online process, in accordance with some embodiments.

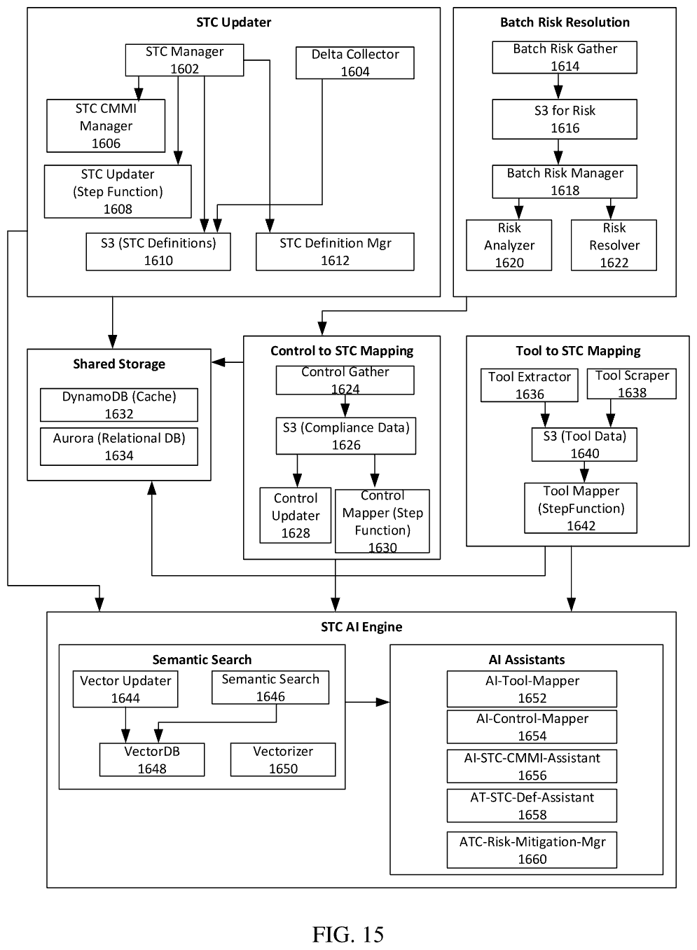

FIG. 15 is an illustration of system architecture for offline process, in accordance with some embodiments.

FIG. 16 is an illustration of mitigation control ranking, in accordance with some embodiments. Further, the mitigation control ranking is based on a scale of P0, P1, P2, and P3. Further, the P0 is a mitigation control with very high risk reduction potential and low LOE or cost. Further, the P3 is a mitigation control with very high LOE/cost, and low risk reduction potential.

Although the invention has been explained in relation to its preferred embodiment, it is to be understood that many other possible modifications and variations can be made without departing from the spirit and scope of the invention as hereinafter claimed.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method for AI-driven security technology rationalization in a multi-cloud or hybrid-cloud computing environment, the method comprising the steps of:
receiving, using a communication device, a security data from a user device, wherein the security data comprises at least one of a security tool, a security risk and a security technology capability maturity assessment data, wherein each is mapped or associable with one or more Security Technology Capabilities (STCs);
processing, using a processing device, the security data to generate intermediate result data, wherein the intermediate result data comprises at least one of a capability benchmark result derived from comparing security capability maturity data with a predefined maturity framework, a tool assessment result based on analysis of tool functionality, gaps, redundancy, or cost efficiency, and a risk analysis result including structured risk components and risk cluster insights, wherein the processing further comprises at least one of normalizing and mapping security tools to corresponding STCs, a resolving security tool duplication by ranking tools into multiple tiers based on a multi-factor analysis, a decomposing risks into structured risk component and mapping the risks to STCs, and an analyzing security technology capability maturity gap with at least one of a security technology maturity framework, prioritizing mitigation based on a compliance requirement and a security deficiency;
analyzing, using the processing device, the intermediate result data based on a security reference data, wherein the security reference data comprises information that is derived from or generated by AI based on one or more external sources including security frameworks, industry benchmarks, compliance standards, or curated datasets, wherein the analyzing comprises at least one of identifying a security technology gap, a redundancy, and a cost inefficiency across the entire portfolio, analyzing a risk and identifying the risk cluster on a Security Technology Capability matrix, prioritizing risk mitigation control based on at least one of a risk reduction effectiveness, a cost, and a level of effort, and determining gaps in a security technology capability and STC maturity;
generating, using the processing device, a security result data based on the analyzing, wherein the result data comprises at least one of a security technology rationalization result and insight, a portfolio X-ray, and an AI-driven recommendation; and
transmitting, using the communication device, the security result data to the user device.

22. The method of claim 21 further comprising the step of:
determining, using the processing device, a plurality of Security Technology Capability (STC) definitions, wherein each of the plurality of STC definitions represents a distinct security technology capability mapped to at least one of a security domain, a security function in public framework, security technologies and emerging technological trend, a compliance framework, and a mitigation control aligned with security risk, wherein the determining is based on at least one of a semantic search and an AI to recommend modification to an existing security technology capability or create a new security technology capability, wherein the determining comprises updating the STC definition to reflect a technological evolution and regulatory and standard updates, wherein the STC definitions are further used to categorize and streamline security tools, analyze security risks, and benchmark security capability maturity to generate insights and recommendations.

23. The method of claim 22 further comprising the step of:
mapping, using the processing device, each security technology capability to at least one of a security domain and a cybersecurity function from a public framework, wherein the mapping comprises associating the security technology capability with a security domain and a major functional function in a public framework, wherein the security domain comprises at least one of data security, identity and access management, wherein the major functional function comprises at least one of identify, protect, detect, respond, and recover, wherein the mapping is dynamically updated based on evolving public frameworks and emerging cybersecurity trends, wherein the resulting mapping is used to organize and structure security data, analyze portfolio gaps, and support generation of security insights and AI-driven recommendations.

24. The method of claim 23 further comprising the step of:
determining and generating, using the processing device, a security technology capability (STC) maturity model, wherein the STC maturity model defines multiple levels security technology capability maturity, each level being defined based on alignment with one or more of security frameworks, compliance controls, mitigation strategies, and technological functions, wherein the maturity model is used to evaluate an organization's built-in security maturity across security technology capabilities, wherein the generating comprises dynamically creating or updating the maturity model using semantic search and AI-based analysis of evolving security standards, risk mitigation strategies, and industry trends.

25. The method of claim 24 further comprising the steps of:
assessing, using the processing device, the capability maturity level of an organization's built-in cyber-defense at both the individual security technology capability level and across the security portfolio; and
applying, using the processing device, the STC maturity model to determine the current maturity level and identifying a maturity gap between the current and target levels, wherein at least one of the assessing and the applying comprises each of using semantic search to identify secure control framework (SCF) controls, mitigation controls, and tools associated with each security technology capability, extracting capability maturity model integration (CMMI) attributes associated with the identified SCF controls, and forwarding the extracted CMMI data, mitigation controls, and other security data to an AI assistant configured to generate an STC-specific maturity model comprising security functions, objectives, and performance metrics, wherein the AI assistant evaluates the security technology capability definition and synthesizes a custom maturity model that aligns with security frameworks, compliance mandates, and threat mitigation strategies, wherein the identified maturity gap is used to prioritize mitigation strategies and generate AI-driven recommendations for maturity improvement.

26. The method of claim 21 further comprising the step of:
mapping a security tool to a security technology capability using an AI-driven process, wherein the mapping is based on at least one of a tool's function, feature set, best-fit security technology capabilities, a semantic search and the AI adjudication to ensure a highly accuracy, wherein the mapped tools are ranked into multiple tiers based on functionality, effectiveness, cost, or redundancy, thereby facilitating tool de-duplication, optimizing security investments, and streamlining the security architecture.

27. The method of claim 21 further comprising the step of:
generating, using the processing device, a security technology capability (STC) matrix, wherein the generating comprises organizing a plurality of STCs into a structured matrix based on mappings a STC to a security domain and a cybersecurity function from a public framework, wherein the mapping comprises mapping each STC to one or more of security risks, including mapped or clustered risk components, security technologies and tools within the organization's portfolio, capability maturity benchmarks and associated performance metrics, mapped mitigation controls from public or internal sources, and compliance control frameworks and security standards, wherein the STC Matrix serves as a multi-dimensional model to analyze security technology issues, risk clusters, maturity gaps, correlate security elements and produce strategic insights including one or more of visualization of portfolio-wide security gaps and redundancies, identification of clustered high-risk areas, detection of low-maturity STCs needing improvement, and generation of heatmaps and spider diagrams to support investment prioritization and mitigation strategies, wherein the STC matrix is dynamically generated or updated based on evolving definitions and frameworks.

28. The method of claim 21 further comprising the step of:
categorizing, using the processing device, a plurality of security elements based on a security technology capability framework, wherein the categorizing comprises an AI-driven determination of mappings between each of a security tool, a compliance control, a framework component, a security risk, and a mitigation control to one or more security technology capabilities, the AI-driven determination being based on at least one of a semantic similarity, a functional coverage, a security objective, or a compliance alignment, wherein the resulting mappings facilitate analysis of security posture, risk exposure, compliance gaps, and optimization opportunities across the security portfolio.

29. The method of claim 28 further comprising the step of:
prioritizing, using the processing device, a set of risk mitigation controls based on an AI-driven analysis, wherein the prioritization is based on at least one of a potential risk reduction, an implementation cost, a level of effort, and an implementation complexity, wherein the prioritizing comprises assigning each mitigation control to a priority tier defined by a risk mitigation prioritization model described in the specification, wherein the risk mitigation prioritization model comprises four levels such as P0 (highest), P1 (high), P2 (moderate), and P3 (low), each based on risk reduction potential, cost, and level of effort, wherein the tiering facilitates the optimization of mitigation control selection, helping the organization achieve maximum risk reduction with minimal cost and level of effort.

30. The method of claim 21, wherein the security result data comprises security technology assessments result and insight, including security tool analysis, identifying functional gaps, overlaps, asset coverage, cost inefficiencies, risk cluster analysis, identifying high-risk areas and mitigation priorities, a security technology capability maturity assessment, identifying capability and maturity gap, wherein the portfolio X-ray comprises an aggregated security visualization of the security posture using heat maps, spider diagrams, and drill down views of tool-level, capability-level, and risk-level issues, wherein the AI-driven recommendations for security optimization, risk reduction, and maturity improvement comprises at least one of strategic and tactical recommendations for tool streamlining, cost reduction, risk mitigation, security technology capability maturity improvement, AI-prioritized mitigation controls based on risk reduction effectiveness, the cost, the level of effort, AI-driven tool recommendations for the most suitable tools to implement mitigation controls, close capability gaps, optimize security investment, and enhance security technology capability maturity.

31. A system for AI-driven security technology rationalization in a multi-cloud or hybrid-cloud computing environment, the system comprising:
a communication device configured for:
obtaining a security tool metadata from multiple sources, including at least one of vendor websites and APIs, as part of an offline tool ingestion process;
receiving a security data from a user device as part of an online tool process, the security data comprising a security tool set submitted for analysis, wherein at least one of the obtaining and the receiving is based on a mode of process comprising at least one of an offline process and an online tool analysis process;
transmitting a security result data to the user device;
a processing device configured for:
storing a precomputed mapping data in a database for real-time analysis, wherein the mapping data includes associations between security tools, security technology capabilities (STCs), and compliance controls;
processing at least one of the security tool metadata and the security data to obtain a processed data, wherein the processing is based on a sematic search and an AI adjudication for the mapping of security tools to corresponding security technology capabilities and compliance control, wherein the processing comprises normalizing the names and cross-references the uploaded data with precomputed mappings, wherein the processing assigns each tool to a security technology capability, wherein tools without existing mappings are dynamically classified based on the semantic matching and the AI adjudication;
analyzing the processed data, wherein the analyzing comprises at least one of a performing tool-level analysis within each security technology capability by evaluating tool's functional coverage, redundancy, and cost efficiency, assessing security capability maturity using a predefined STC maturity model, and classifying risks into risk clusters using security technology capability matrix; and
generating the security result data based on the analysis, wherein the security result data comprises an interactive portfolio X-Ray of security assessment that provides a real-time view of security risks, gaps, and optimization opportunities.

32. The system of claim 31, wherein the processing device is further configured for:
obtaining updates on security technologies and tool metadata from one or more external sources periodically;
processing the obtained updates using semantic search and AI-based analysis; and
updating the tool database and the mapping between tools and security technology capabilities dynamically based on the received data.

33. The system of claim 31, wherein the processing device is further configured for
generating or updating a security technology capability definition based on evolving security technologies, trends, and industry standards, wherein the security technology capability definition represents at least one of a purpose, a functionality, a scope, and a description, wherein the generation is performed by a security technology capability definition engine;
identifying impacted security technology capabilities by analyzing changes in security tool features, industry trends, public security frameworks, and regulatory controls; and
forwarding detected changes to the AI-powered adjudication module, wherein the identifying and forwarding is based on a semantic search module.

34. The system of clam 33, wherein the processing device is further configured for
evaluating external changes to identify candidate security technology capabilities (STCs) for update, determine necessary security technology capability updates or realignments, and provide security technology capability modification recommendations, wherein the evaluating is performed using semantic search and an AI-powered adjudication module;
tracking historical changes to security technology capability definitions, security tool mappings, and compliance alignments, ensuring auditability, wherein the tracking is performed by a versioning and governance module; and
ingesting security technologies, mitigation controls, public standards to trigger AI-driven updates to the STC definitions, wherein the ingestion and update are performed using a periodic mechanism in combination with semantic search and AI-based adjudication.

35. The system of claim 31, wherein the processing device is further configured for:
utilizing semantic search for identifying relevant secure framework components gathering associated controls and Capability Maturity Model Integration (CMMI) data for a security technology capability, and forwarding this information to the AI assistant for synthesizing a security technology capability-specific maturity definition, wherein the AI assistant is configured to process the security technology capability definition, evaluate mapped security controls and their CMMI definitions, and generate a maturity model for the security technology capability, wherein the maturity model is associated with at least one of a security functions, objectives, and performance metrics for the security technology capability; and
maintaining historical versions of security technology capability maturity model for ensuring continuous updates and compliance with evolving security standards, wherein the maintenance is based on a versioning and governance system.

36. The system of claim 31, wherein the processing device is further configured for
identifying changed compliance controls from at least one of a compliance regulation and/or a security framework, wherein the compliance regulation comprises at least one of NIST 800-53, ISO 27001, PCI DSS 4.0, or other applicable regulatory standards, wherein the security framework comprises a security control framework (SCF) or similar industry framework;
identifying the most relevant security technology capabilities for at least one of the regulatory control and a framework component using semantic search;
evaluating relevant data from semantic search and determining the final mapping between the compliance control, the framework component and the security technology capabilities, wherein each of the evaluating and determining is based on semantic search and AI-powered adjudication;
detecting changes in regulations, security frameworks, and security technology capability definitions;
adjusting the mapping between them, wherein each of the detecting and the adjusting is based on a continuous compliance mapping engine; and
maintaining historical compliance mappings, version tracking, and audit logs for regulatory assessments, wherein the maintaining is performed by a versioning and retrieval system.

37. The system of claim 31, wherein the processing device is further configured for:
identifying candidate security tools for resolving at least one of a plurality of security technology capability gap using semantic search, wherein the security technology capability gap comprises at least one of an absence of the security tool for a security technology capability, a partial functional coverage within the security technology capability, and a maturity-level deficiency within the security technology capability (illustrative examples omitted; described in specification);
assessing candidate tools based on functional coverage, effectiveness in closing the gap, cost, and organization-specific criteria;
determining the optimal tool or combination of tools to close the identified security technology capability gap;
ranking recommendations based on organization-defined selection priorities, wherein each of the assess, the determine, and the rank is based on an AI-driven tool evaluation module; and
ingesting new security tool data, including emerging threats and evolving compliance requirements and continuously refine AI-driven tool recommendations based on real-time security need, wherein at least one of the ingesting and the continuous refine is based on a continuous update engine.

38. The system of claim 31, wherein the processing device is further configured for:
analyzing each security risk;
decomposing a risk into organized actionable risk components;
generating prioritized risk mitigation controls based on risk reduction effectiveness, cost, and implementation effort, wherein each of the analyzing, decomposing and the generating is based on an AI-powered mitigation control module;
identifying the most suitable security tools capable of implementing AI-generated risk mitigation control based on a security tool candidate module and a semantic search;
evaluating the security tool;
ranking the security tool based on at least one of a risk reduction effectiveness, a cost, an implementation effort, and a compatibility with must-have security tool;
adjusting recommendation based on organization-specific priority dynamically; and
generating AI-driven explanation for tool ranking to enhance transparency, wherein the ranking comprises an AI explanation sub-module configured to generate human-understandable rationale for ranking decisions based on various factors, wherein each of the evaluating, the adjusting and the generating is based on a semantic search and AI-driven risk analysis, mitigation controls generation and ranking, tool recommendations module.

39. The system of claim 31, wherein the processing device is further configured for:
analyzing at least one of a security risk, a risk component, and a mitigation control for the risk dynamically;
locating candidate security technology capabilities using semantic search;
adjudicating the proper mapping between risks, mitigation controls, and the security technology capabilities using an AI, wherein each of the analyzing, locating, and adjudicating is performed by a set of AI-driven risk and control modules;
aggregating and quantifying risk across multiple security technology capabilities;
grouping risks into clusters;
determining high risk cluster;
prioritizing risk mitigation based on AI-driven cost-benefit analysis, wherein each of the aggregating, the quantifying, the determining, the grouping, and the prioritizing is based on an AI-driven portfolio risk analyzing engine; and
providing at least one of a real-time aggregated view of risk distribution across the security technology capabilities, and an actionable insight to prioritize risk mitigation efforts, wherein the providing is based on at least one of a visualization module and an insight module that generates a risk heat map.

40. The system of claim 31, wherein the communication device is further configured for receiving a security tool data from multiple sources, including vendor databases, API integrations, security catalogs, and enterprise asset inventories, wherein the processing device is configured for:
mapping security tools to the most relevant security technology capabilities based on at least one of a tool functionality and feature set, security technology capability scope and definitions, wherein the mapping is further based on semantic search and AI adjudication;
ingesting security technology trends from public research, vendor whitepapers, industry reports, and security framework updates;
breaking a major trend down into its components;
identifying emerging technologies, key functions, and features, using semantic search and AI adjudication to map security trends or micro-trends to security technology capability;
recommending updates to security technology capability definitions based on the evolution of security tools and technologies;
updating the security tool-to-security technology capability mapping as new security tools emerge or existing tools evolve periodically;
adjusting security technology capability definitions based on industry trends and changes in cybersecurity best practices dynamically; and
refining mappings and ensure alignment with evolving security architecture using AI-assisted adjudication, wherein each of the updating, the dynamically adjusting and the AI-assisted adjudication is based on an AI-driven continuous update and refinement module.

41. A method for categorizing security-related data using a security technology capability (STC) framework, the method comprising:
receiving, using a communication device, a plurality of security elements, wherein the security elements include at least one of security tools, compliance controls, framework components, risks, and risk mitigation controls;
mapping, using a processing device, the security elements to corresponding security technology capabilities based on at least one of STC scope and objectives, tool functions or features, risk and mitigation alignment, and compliance alignment, wherein the mapping uses semantic search and AI-based adjudication; and
storing, using the processing device, the resulting mappings in a structured representation, enabling cross-domain analysis of risks, mitigation controls, and tool portfolios within the STC framework; and dynamically updating the mapping based on evolving frameworks, standards, and security technologies.
